(19) United States
(12) Patent Application Publication
(10) Pub. No.: US 2026/0222934 A1
(43) Pub. Date: Jul. 30, 2026

(54) METHODS AND APPARATUS FOR PERFORMING LTM IN A WIRELESS COMMUNICATION SYSTEM

(71) Applicant: Samsung Electronics Co., Ltd., Suwon-si, Gyeonggi-do (KR)

(72) Inventor: Aby Kanneath ABRAHAM, Bangalore (IN)

(21) Appl. No.: 19/147,582

(22) PCT Filed: May 3, 2024
(86) PCT No.: PCT/KR2024/005969

§ 371 Date: Jul. 11, 2025

(30) Foreign Application Priority Data
May 3, 2023 (IN) 202341031542
May 9, 2023 (IN) 202341032869
Apr. 18, 2024 (IN) 2023 41031542

(51) Int. Cl. H04W 36/00; H04W 36/08

(52) U.S. Cl. CPC H04W 36/008357; H04W 36/0058; H04W 36/0061; H04W 36/08

(57) ABSTRACT

The disclosure relates to a 5G or 6G communication system for supporting a higher data transmission rate. Embodiments disclosed herein relate to methods (200) and systems (100) for managing a Lower-layer Triggered Mobility (LTM) in wireless communication networks for both a User Equipment (UE) (104) and a network. The methods (200) include configuring and performing of mobility in equivalent Stand-alone Non-Public Network (SNPN). The methods (200) include addressing a Centralized Unit (CU)-Distributed Unit (DU) (CU-DU) interaction for handling a reference configuration for LTM. Further, the methods (200) include handling of LTM configuration during a Radio Resource Control (RRC) reestablishment. Further, a Near Radio (NR) sidelink discovery procedure is performed by configuring the UE (104) with sl-RxPool and sl-DiscRxPool for NR sidelink discovery reception in LTM candidate cell configuration. The methods (200) include interaction of a Master Node (MN) (128) and a Secondary Node (SN) (130) for a Random Access Channel (RACH) configuration for early Timing Advance (TA) acquisition.

### TECHNICAL FIELD

Embodiments disclosed herein relate to wireless communication networks, and more particularly to managing Lower-layer Triggered Mobility (LTM) in wireless communication networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

the embodiments herein provide a method for handling a Lower-layer Triggered Mobility (LTM) configuration. The method comprises identifying, by a base station, at least one neighbor cell as one of a candidate cell for a LTM, a target cell for a Layer3 (L3) handover, and a candidate cell for a conditional handover. The method comprises verifying, by the base station, if the identified neighbor cell supports a serving Stand-alone Non-Public Network (SNPN) ID or an SNPN ID of an equivalent SNPN. The method comprises configuring, by the base station, the neighbor cell as one of the candidate cell for the LTM, the target cell for L3 handover, and the candidate cell for the conditional handover, if the neighbor cell supports the serving SNPN ID or the SNPN ID of an equivalent SNPN. Thereafter, the method comprises skipping, by the base station, configuration of the neighbor cell, if the neighbor cell does not support the serving SNPN ID or the SNPN ID of an equivalent SNPN.

the embodiments herein provide a base station which comprises a processor, and a memory module. The processor is coupled with the memory module, and configured to identify at least one neighbor cell as one of a candidate cell for a LTM, a target cell for a L3 handover, and a candidate cell for a conditional handover. The processor is configured to verify if the identified neighbor cell supports a serving SNPN ID or an SNPN ID of an equivalent SNPN. The processor is configured to configure the neighbor cell as one of the candidate cell for the LTM, the target cell for L3 handover, and the candidate cell for the conditional handover, if the neighbor cell supports the serving SNPN ID or the SNPN ID of an equivalent SNPN. The processor is configured to skip configuration of the neighbor cell, if the neighbor cell does not support the serving SNPN ID or the SNPN ID of an equivalent SNPN.

the embodiments herein provide a User Equipment (UE) which comprises a processor and a memory module. The processor is coupled with the memory module, and configured to receive at least one configured LTM candidate cell of the LTM configuration from a base station. The processor is configured to remove entries of one or more UE configurations within at least one UE variable for at least one of a Master Cell Group (MCG), and a Secondary Cell Group (SCG), after receiving the configured LTM candidate cell of the LTM configuration. The processor is configured to store the configured LTM candidate cell in the UE variable during a Radio Resource Control (RRC) reestablishment procedure, after removing the entries of the UE configurations.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 depicts a system for handling a LTM configuration, according to embodiments as disclosed herein;

FIG. 2 depicts a method for handling the LTM configuration, according to embodiments as disclosed herein;

FIG. 3 depicts a method for handling UE configurations based on a RLF or LTM execution failure, according to embodiments as disclosed herein;

FIG. 4 depicts a process of handling generated LTM configurations during a RRC reestablishment, according to embodiments as disclosed herein;

FIG. 5 depicts a process of handling a generated LTM configuration for RRC resume, according to embodiments as disclosed herein;

FIG. 6 depicts a flow process for performing a LTM candidate cell configuration for a Non-Public Network (NPN), according to embodiments as disclosed herein;

FIG. 7 depicts a flow process of performing L3 mobility candidate cell/target cell configuration for NPN with equivalent SNPN, according to embodiments as disclosed herein;

FIG. 8 depicts a sequence diagram for configuring LTM for NR sidelink discovery and PUCCH configuration, according to embodiments as disclosed herein;

FIG. 9A depicts a method for sending a notification message in a sidelink, according to embodiments as disclosed herein; and

FIG. 9B depicts a sequence diagram of receiving the notification message in sidelink, according to embodiments as disclosed herein.

FIG. 10 illustrates a structure of a base station (BS) according to an embodiment of the disclosure.

FIG. 11 illustrates a structure of a user equipment (UE) according to an embodiment of the disclosure.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The User Equipments (UEs) can be camped to a Public Land Mobile Networks (PLMN) or a Non-Public Network (NPN). NPN can be a Stand-alone Non-Public Network (SNPN), when not relying on network functions provided by the PLMN; or a Public Network Integrated (PNI) NPN when relying on the PLMN.

In wireless technologies like 5G New Radio (NR), devices can move across different cells. Mobility is performed using a procedure called cell reselection in an Radio Resource Control (RRC)_IDLE mode. Till NR R17, mobility was performed using a procedure called handover in RRC_CONNECTED mode. Network controlled mobility applies to UEs in RRC_CONNECTED mode. The mobility requires explicit RRC signalling to be triggered by a gNB in NR. Handover in NR usually consists of three steps: handover preparation, handover execution and handover completion. The gNB may configure the UE to report measurements and based on the reported measurements or based on its own understanding of the network topology, the gNB will send a RRC Reconfiguration message to handover the UE to another cell (referred to herein as a target cell) from a source cell. The UE accesses the target cell and sends RRC Reconfiguration complete message. In an alternative way introduced in 3GPP NR release 16, the gNB may configure the UE with the execution conditions for triggering handover. Once the execution conditions are satisfied, the UE may move to target cell and sends the RRC Reconfiguration complete. In all the above methods, the UE can perform handover by sending layer 3 (RRC) messages which may cause considerable signalling overhead and latency issues. During handover, the UE may be configured to apply a full configuration during a L3 handover, and if configured, the UE applies full configuration as described in section 5.3.5.11 of TS 38.331. The handover, and conditional handover (CHO) can be referred to herein as a layer 3 (L3) mobility. In case of dual connectivity, the UE may perform PSCellChange or Conditional PSCellChange. In the context of dual connectivity, PSCellChange or Conditional PSCellChange can also be referred to herein as layer 3 mobility. Handover, Conditional Handover, PSCellChange, Conditional PSCellChange, and so on refer to L3 mobility. PSCellChange or Conditional PSCellChange may be referred to herein as Secondary Cell Group (SCG) layer 3 mobility, and the handover and the CHO as MCG layer 3 mobility in the context of dual connectivity.

GPP specifications such as TS38.300, TS38.331, TS 38.321 (such as version v17.3.0) can also be considered as relevant background.

3GPP release 18 is considering Lower layers (L1/L2 layers) Triggered Mobility, also known as LTM to solve this problem. As per 3GPP, the goal of LTM is to enable a serving cell change via L1/L2 signalling, in order to reduce the latency, overhead and interruption time. The network (gNB) may configure the UE with multiple candidate cells to allow fast application of configurations for candidate cells. The network may further send Medium Access Control (MAC) Control Element (CE) or L1 signalling to dynamically switch the UE from a source cell to one of the configured candidate cells. Further, LTM can be triggered based on L1 measurements rather than L3 measurements. The UE may receive LTM measurement configuration from the gNB which are L1 measurement configuration which tells the UE what to measure, how to report, what to report, and so on.

3GPP proposes to perform LTM, without reset of lower layers like MAC to avoid data loss and to reduce additional delay of data recovery wherever it is possible. The gNB may provide LTM Candidate Configuration; i.e., configure the LTM candidate cells through one RRC Reconfiguration message for a candidate target cell or through one CellGroupConfig for each candidate target cell or through any similar RRC structure or IE containing the similar fields (for example, a new IE LTM-CandidateConfig can be defined as ASN.1 sequence containing cellgroupconfig and some other information elements in the RRC Reconfiguration). The gNB may further release or modify the candidate configurations. A UE may store the LTM configuration of other candidate cells even after moving to a candidate cell through LTM.

To avoid transmitting a large message over air interface, the gNB can provide the LTMCandidateConfiguration as delta configuration instead of full configuration. The gNB can indicate the UE to use the source cell configuration as the reference for delta configuration or provide the reference configuration explicitly.

The gNB may provide LTMCandidateConfiguration; i.e., configure the LTM candidate cells through one RRCReconfiguration message for a candidate target cell or through one CellGroupConfig for each candidate target cell or through any similar RRC structure or IE containing the similar fields (for example, a new IE LTM-CandidateConfig can be defined as ASN.1 sequence containing CellGroupConfig and some other information elements in the RRCReconfiguration). The gNB may further release or modify the candidate configurations. A UE may store the LTM configuration of other candidate cells even after moving to a candidate cell through LTM. The gNB also may provide the UE with configuration for performing LTM measurements for different candidate frequencies and candidate cells, and reporting based on the performed LTM measurements.

The gNB provides reference configuration, L1 measurement configuration, and candidate cell configuration in a RRC ASN.1 SEQUENCE used for LTM Configuration.

An example specification for the configuration and operation of LTM is given as below:

ASN1START
-- TAG-RRCRECONFIGURATION-START

| | |
|---|---|
| RRCReconfiguration ::= | SEQUENCE { |
| rrc-TransactionIdentifier | RRC-TransactionIdentifier, |
| criticalExtensions | CHOICE { |

| | |
|---|---|
| rrcReconfiguration | RRCReconfiguration-Ies, |
| criticalExtensionsFuture | SEQUENCE { } |

}
}

| | |
|---|---|
| RRCReconfiguration-Ies ::= | SEQUENCE { |

| | | |
|---|---|---|
| radioBearerConfig | RadioBearerConfig | OPTIONAL, |

-- Need M

| | |
|---|---|
| secondaryCellGroup | OCTET STRING (CONTAINING CellGroupConfig) |

OPTIONAL, -- Cond SCG

| | | |
|---|---|---|
| measConfig | MeasConfig | OPTIONAL, |

-- Need M

| | | |
|---|---|---|
| lateNonCriticalExtension | OCTET STRING | OPTIONAL, |

| | |
|---|---|
| nonCriticalExtension | RRCReconfiguration-v1530-Ies |

OPTIONAL
}

| | |
|---|---|
| RRCReconfiguration-v1530-Ies ::= | SEQUENCE { |

| | |
|---|---|
| masterCellGroup | OCTET STRING (CONTAINING CellGroupConfig) |

OPTIONAL, -- Need M

| | | |
|---|---|---|
| fullConfig | ENUMERATED {true} | OPTIONAL, |

-- Cond FullConfig

| | |
|---|---|
| dedicatedNAS-MessageList | SEQUENCE (SIZE(1..maxDRB)) OF DedicatedNAS- |

| | |
|---|---|
| Message | OPTIONAL, -- Cond nonHO |

| | | |
|---|---|---|
| masterKeyUpdate | MasterKeyUpdate | OPTIONAL, |

-- Cond MasterKeyChange

| | |
|---|---|
| dedicatedSIB1-Delivery | OCTET STRING (CONTAINING SIB1) |

OPTIONAL, -- Need N

| | |
|---|---|
| dedicatedSystemInformationDelivery | OCTET STRING (CONTAINING |

| SystemInformation) | OPTIONAL, -- Need N | |
|---|---|---|
| otherConfig | OtherConfig | OPTIONAL, |

-- Need M

| | |
|---|---|
| nonCriticalExtension | RRCReconfiguration-v1540-Ies |

OPTIONAL
}

| | |
|---|---|
| RRCReconfiguration-v1540-Ies ::= | SEQUENCE { |

| | | |
|---|---|---|
| otherConfig-v1540 | OtherConfig-v1540 | OPTIONAL, |

-- Need M

| | |
|---|---|
| nonCriticalExtension | RRCReconfiguration-v1560-Ies |

OPTIONAL
}

| | |
|---|---|
| RRCReconfiguration-v1560-Ies ::= | SEQUENCE { |

| | |
|---|---|
| mrdc-SecondaryCellGroupConfig | SetupRelease { MRDC- |

| | |
|---|---|
| SecondaryCellGroupConfig } | OPTIONAL, -- Need M |

| | |
|---|---|
| radioBearerConfig2 | OCTET STRING (CONTAINING RadioBearerConfig) |

OPTIONAL, -- Need M

| | | |
|---|---|---|
| sk-Counter | SK-Counter | OPTIONAL, |

-- Need N

| | |
|---|---|
| nonCriticalExtension | RRCReconfiguration-v1610-Ies |

OPTIONAL
}

| | |
|---|---|
| RRCReconfiguration-v1610-Ies ::= | SEQUENCE { |

| | | |
|---|---|---|
| otherConfig-v1610 | OtherConfig-v1610 | OPTIONAL, |

-- Need M

| | |
|---|---|
| bap-Config-r16 | SetupRelease { BAP-Config-r16 } |

OPTIONAL, -- Need M

| | |
|---|---|
| iab-IP-AddressConfigurationList-r16 | IAB-IP-AddressConfigurationList-r16 |

OPTIONAL, -- Need M

| | |
|---|---|
| conditionalReconfiguration-r16 | ConditionalReconfiguration-r16 |

OPTIONAL, -- Need M

| | |
|---|---|
| daps-SourceRelease-r16 | ENUMERATED{true} |

OPTIONAL, -- Need N

| | | |
|---|---|---|
| t316-r16 | SetupRelease {T316-r16} | OPTIONAL, |

-- Need M

| | |
|---|---|
| needForGapsConfigNR-r16 | SetupRelease {NeedForGapsConfigNR-r16} |

OPTIONAL, -- Need M

| | |
|---|---|
| onDemandSIB-Request-r16 | SetupRelease { OnDemandSIB-Request-r16 } |

OPTIONAL, -- Need M

| | |
|---|---|
| dedicatedPosSysInfoDelivery-r16 | OCTET STRING (CONTAINING |

| | |
|---|---|
| PosSystemInformation-r16-Ies) | OPTIONAL, -- Need N |

| | |
|---|---|
| sl-ConfigDedicatedNR-r16 | SetupRelease {SL-ConfigDedicatedNR-r16} |

OPTIONAL, -- Need M

| | |
|---|---|
| sl-ConfigDedicatedEUTRA-Info-r16 | SetupRelease {SL-ConfigDedicatedEUTRA-Info- |

| | |
|---|---|
| r16} | OPTIONAL, -- Need M |

| | | |
|---|---|---|
| targetCellSMTC-SCG-r16 | SSB-MTC | OPTIONAL, |

-- Need S

| | |
|---|---|
| nonCriticalExtension | RRCReconfiguration-v1700-Ies |

OPTIONAL
}

| | |
|---|---|
| RRCReconfiguration-v1700-Ies ::= | SEQUENCE { |

| | | |
|---|---|---|
| otherConfig-v1700 | OtherConfig-v1700 | OPTIONAL, |

-- Need M

| | |
|---|---|
| sl-L2RelayUE-Config-r17 | SetupRelease { SL-L2RelayUE-Config-r17 } |

OPTIONAL, -- Need M

| | |
|---|---|
| sl-L2RemoteUE-Config-r17 | SetupRelease { SL-L2RemoteUE-Config-r17 } |

OPTIONAL, -- Need M

| | |
|---|---|
| dedicatedPagingDelivery-r17 | OCTET STRING (CONTAINING Paging) |

OPTIONAL, -- Cond PagingRelay

| | |
|---|---|
| needForGapNCSG-ConfigNR-r17 | SetupRelease {NeedForGapNCSG-ConfigNR- |

| | |
|---|---|
| r17} | OPTIONAL, -- Need M |

| | |
|---|---|
| needForGapNCSG-ConfigEUTRA-r17 | SetupRelease {NeedForGapNCSG- |

| | |
|---|---|
| ConfigEUTRA-r17} | OPTIONAL, -- Need M |

| | |
|---|---|
| musim-GapConfig-r17 | SetupRelease {MUSIM-GapConfig-r17} |

OPTIONAL, -- Need M

| | |
|---|---|
| ul-GapFR2-Config-r17 | SetupRelease { UL-GapFR2-Config-r17 } |

OPTIONAL, -- Need M

| | | |
|---|---|---|
| scg-State-r17 | ENUMERATED { deactivated } | OPTIONAL, |

-- Need N

| | |
|---|---|
| appLayerMeasConfig-r17 | AppLayerMeasConfig-r17 |

OPTIONAL, -- Need M

| | |
|---|---|
| ue-TxTEG-RequestUL-TDOA-Config-r17 | SetupRelease {UE-TxTEG-RequestUL- |

| | |
|---|---|
| TDOA-Config-r17} | OPTIONAL, -- Need M |

| | |
|---|---|
| nonCriticalExtension | RRCReconfiguration-v18xy |

OPTIONAL
}

| | |
|---|---|
| RRCReconfiguration-v18xy-Ies ::= | SEQUENCE { |

| | |
|---|---|
| ltm-CandidateConfig-r18 | SetupRelease {LTM-CandidateConfig-r18} |

OPTIONAL, -- Need M

| | | |
|---|---|---|
| nonCriticalExtension | SEQUENCE { } | OPTIONAL |

}

### Radio Resource Control Information Elements:

The IE LTM-CandidateConfig can be used to provide LTM candidate cell configuration. If the UE receives the RRC Reconfiguration including LTM candidate configuration, the UE performs LTM configuration. An example sequence for LTM candidate configuration executed by the UE is given below (in the baseline CR for TS 38.331).

### 5.3.5.x LTM Configuration and Execution

### x.1 General

The UE shall perform the following actions based on a received LTM-CandidateConfig IE:
> store the received ltm-ReferenceConfiguration in VarLTM-Config, if present;
1> if the LTM-CandidateConfig includes the ltm-CandidateToReleaseList:
2> perform the LTM candidate cell release as specified in 5.3.5.x.2;
> if the LTM-CandidateConfig includes the ltm-CandidateResetL2-List:
2> add the received ltm-CandidateResetL2-List to VarLTM-Config;
1> if the LTM-CandidateConfig includes the ltm-CandidateToAddModList:
2> perform the LTM candidate cell addition or reconfiguration as specified in 5.3.5.x.3;
1> perform the actions to generate a complete LTM configuration as specified in 5.3.5.x.4;

NOTE X: It is up to the UE implementation to postpone the generation of a complete LTM configuration until the executing of an LTM cell switch.

### 5.3.5.x.2 LTM Candidate Cell Release

The UE shall:
1> for each ltm-CandidateId in the ltm-CandidateToReleaseList:
2> if the current VarLTM-Config includes an ltm-Candidate with the given ltm-CandidateId:
3> release the ltm-Candidate from VarLTM-Config;

### 5.3.5.x.3 LTM Candidate Cell Addition/Modification

The UE shall:
1> for each ltm-CandidateId in the ltm-CandidateToAddModList:
2> if the current VarLTM-Config includes an ltm-Candidate with the given ltm-CandidateId:
3> modify the ltm-Candidate within VarLTM-Config in accordance with the received ltm-Candidate;
2> else:
3> add the received ltm-Candidate to VarLTM-Config.

### 5.3.5.x.4 Generation of UE LTM Configuration

The purpose of this procedure is for the UE to generate a complete LTM candidate cell configuration to be stored and applied only when an indication of an LTM cell switch is received by lower layers. During the generation of a complete LTM candidate cell configuration, the current UE configuration shall not be modified.

The UE shall:
1> for each ltm-Candidate in ltm-CandidateConfigList within VarLTM-Config;
2> store the ltm-CandidateId included in ltm-Candidate within VarLTM-UE-Config;
2> if ltm-Candidate includes ltm-ConfigComplete;
3> generate a complete LTM candidate cell configuration for the received ltm-Candidate according to the actions described in clause 5.3.5.3 and store it in ue-LTM-Config within VarLTM-UE-Config.
2> else:
3> generate a complete LTM candidate cell configuration by applying ltm-Candidate on top of referenceConfiguration according to the actions described in clause 5.3.5.3 and store it in ue-LTM-Config within VarLTM-UE-Config.

### 5.3.5.x.5 LTM Cell Switch Execution

Upon the indication by lower layers that an LTM cell switch procedure is triggered, the UE shall:
1> release/clear all current dedicated radio configuration except for the following:
2> if the LTM cell switch is triggered on the Master Cell Group (MCG):
   the MCG (Cell-Radio Network Temporary Identifier) C-RNTI;
   the Access Stratum (AS) security configurations associated with the master key;
2> else, if the LTM cell switch is triggered on the SCG:
   the SCG C-RNTI;
   the AS security configurations associated with the secondary key;
   the Signalling Radio Bearers 1 (SRB1)/SRB2 configurations and Data Radio Bearer (DRB) configurations as configured by radioBearerConfig or radioBearerConfig2;
   the UE variables VarLTM-Config and VarLTM-UE-Config.
1> release/clear all current common radio configuration;
1> use the default values specified in 9.2.3 for timers T310, T311 and constants N310, N311;
1> apply the default L1 parameter values as specified in corresponding physical layer specifications except for the following:
   parameters for which values are provided in System Information Block1 (SIB1);
1> apply the value of the newUE-Identity as the C-RNTI for this cell group according to the LTM candidate cell configuration related to the LTM candidate cell configuration identity as received by lower layers;
1> configure lower layers in accordance with the received spCellConfigCommon according to the LTM candidate cell configuration indicated by lower layers;
1> configure lower layers in accordance with the received rach-ConfigDedicated according to the LTM candidate cell configuration indicated by lower layers.
1> configure the Packet Data Convergence Protocol (PDCP) entity for LTM candidate cell configuration indicated by lower layers with state variables continuation as specified in TS 38.323, and with the same security configuration as the PDCP entity for the source cell group;
1> stop timer T310 for the corresponding Special Cell (SpCell), if running;
1> if this procedure is executed for the MCG:
2> if timer T316 is running;
3> stop timer T316;
1> stop timer T312 for the corresponding SpCell, if running;
1> apply the specified BCCH configuration defined in 9.1.1.1 for the target LTM candidate cell configuration;
1> acquire the MIB of the target SpCell as indicated in the LTM candidate cell configuration indicated by lower layers, which is scheduled as specified in TS 38.213, if applicable;
1> apply the LTM configuration in UE-LTM-Config within VarLTM-UE-Config related to the LTM candidate cell configuration identity as received by lower layers.
1> submit the RRCReconfigurationComplete message to lower layers for transmission using the new configuration.

| | |
|---|---|
| RRCReconfiguration-v1700-Ies ::= | SEQUENCE { |

| | | |
|---|---|---|
| otherConfig-v1700 | OtherConfig-v1700 | OPTIONAL, |

-- Need M

| | |
|---|---|
| sl-L2RelayUE-Config-r17 | SetupRelease { SL-L2RelayUE-Config-r17 } |

OPTIONAL, -- Need M

| | |
|---|---|
| sl-L2RemoteUE-Config-r17 | SetupRelease { SL-L2RemoteUE-Config-r17 } |

OPTIONAL, -- Need M

| | |
|---|---|
| dedicatedPagingDelivery-r17 | OCTET STRING (CONTAINING Paging) |

OPTIONAL, -- Cond PagingRelay

| | |
|---|---|
| needForGapNCSG-ConfigNR-r17 | SetupRelease {NeedForGapNCSG-ConfigNR- |

| | |
|---|---|
| r17} | OPTIONAL, -- Need M |

| | |
|---|---|
| needForGapNCSG-ConfigEUTRA-r17 | SetupRelease {NeedForGapNCSG- |

| | |
|---|---|
| ConfigEUTRA-r17} | OPTIONAL, -- Need M |

| | |
|---|---|
| musim-GapConfig-r17 | SetupRelease {MUSIM-GapConfig-r17} |

OPTIONAL, -- Need M

| | |
|---|---|
| ul-GapFR2-Config-r17 | SetupRelease { UL-GapFR2-Config-r17 } |

OPTIONAL, -- Need M

| | | |
|---|---|---|
| scg-State-r17 | ENUMERATED { deactivated } | OPTIONAL, |

-- Need N

| | |
|---|---|
| appLayerMeasConfig-r17 | AppLayerMeasConfig-r17 |

OPTIONAL, -- Need M

| | |
|---|---|
| ue-TxTEG-RequestUL-TDOA-Config-r17 | SetupRelease {UE-TxTEG-RequestUL- |

| | |
|---|---|
| TDOA-Config-r17} | OPTIONAL, -- Need M |

| | |
|---|---|
| nonCriticalExtension | RRCReconfiguration-v18xy |

OPTIONAL
}

| | |
|---|---|
| RRCReconfiguration-v18xy-Ies ::= | SEQUENCE { |
| ltm-CandidateConfig-r18 | SetupRelease {LTM-CandidateConfig-r18} |

OPIONAL, -- Need M

| | | |
|---|---|---|
| nonCriticalExtension | SEQUENCE { } | OPTIONAL |

}
Ltm-CandidateConfig
Configuration of LTM candidate cell(s), reference configuration for LTM cell(s) and sets of
cells in which full L2 reset is applied upon an LTM cell switch.
-- Serving cell specific MAC and physical layer (PHY) parameters for a SpCell:

| SpCellConfig ::= | SEQUENCE { | |
|---|---|---|
| servCellIndex | ServCellIndex | OPTIONAL, -- |

Cond SCG

| | | |
|---|---|---|
| reconfigurationWithSync | ReconfigurationWithSync | OPTIONAL, |

-- Cond ReconfWithSync

| | |
|---|---|
| rlf-TimersAndConstants | SetupRelease { RLF-TimersAndConstants } |

OPTIONAL, -- Need M

| | |
|---|---|
| rlmInSyncOutOfSyncThreshold | ENUMERATED {n1} |

OPTIONAL, -- Need S

| | | |
|---|---|---|
| spCellConfigDedicated | ServingCellConfig | OPTIONAL, |

```
-- Need M
  ...,
  [[
```

| | |
|---|---|
| lowMobilityEvaluationConnected-r17 | SEQUENCE { |
| s-SearchDeltaP-Connected-r17 | ENUMERATED {dB3, dB6, dB9, dB12, dB15, |

spare3, spare2, spare1},

| | |
|---|---|
| t-SearchDeltaP-Connected-r17 | ENUMERATED {s5, s10, s20, s30, s60, s120, s180, |

s240, s300, spare7, spare6, spare5,

spare4, spare3, spare2, spare1}

| | |
|---|---|
| } | OPTIONAL, --- Need R |
| goodServingCellEvaluationRLM-r17 | GoodServingCellEvaluation-r17 |

OPTIONAL, -- Need R

| | |
|---|---|
| goodServingCellEvaluationBFD-r17 | GoodServingCellEvaluation-r17 |

OPTIONAL, -- Need R

| | |
|---|---|
| deactivatedSCG-Config-r17 | SetupRelease { DeactivatedSCG-Config-r17 } |

OPTIONAL -- Cond SCG-Opt
]],

| | | |
|---|---|---|
| ltmCellSwitchInfo | SetupRelease { LtmCellSwitchInfo } | OPTIONAL |

-- Need M
}

| LtmCellSwitchInfo-r18 ::= | SEQUENCE { | |
|---|---|---|
| spCellConfigCommon | ServingCellConfigCommon | OPTIONAL, |

-- Need M

| | |
|---|---|
| newUE-Identity | RNTI-Value, |
| rach-ConfigDedicated | CHOICE { |
| uplink | RACH-ConfigDedicated, |
| supplementaryUplink | RACH-ConfigDedicated |

| | |
|---|---|
| } | OPTIONAL, -- Need N |

}

ltmCellSwitchInfo: This field contains necessary information for the UE to execute an LTM cell switch procedure in case this cell is a LTM target cell.

LTM-CandidateConfig: The IE LTM-CandidateConfig is used to provide LTM candidate cell configuration.

The LTM-CandidateConfig information element is as follows:

-- ASN1START
-- TAG-LTM-CANDIDATECONFIG-START
LTM-CandidateConfig-r18 ::= SEQUENCE {

| | |
|---|---|
| lte-ReferenceConfiguration-r18 | OCTET STRING (CONTAINING |

| | |
|---|---|
| RRCReconfiguration), | OPTIONAL, -- Cond FirstLTM-Candidate |

| | |
|---|---|
| ltm-CandidateToReleaseList-r18 | LTM-CandidateToReleaseList-r18 |

OPTIONAL, -- Need N

| | |
|---|---|
| ltm-CandidateToAddModList-r18 | LTM-CandidateToAddModList-r18 |

OPTIONAL, -- Need N

| | |
|---|---|
| ltm-CandidateResetL2-List-r18 | SetupRelease { LTM-CandidateResetL2-List-r18 } |

OPTIONAL -- Need M
...
}
LTM-CandidateToReleaseList-r18 ::= SEQUENCE (SIZE (1..maxNrofCellsLTM-r18)) OF

| | |
|---|---|
| LTM-CandidateId-r18 | OPTIONAL -- Need N |

LTM-CandidateToAddModList-r18 ::= SEQUENCE (SIZE (1..maxNrofCellsLTM-r18)) OF
LTM-Candidate-r18

| | |
|---|---|
| LTM-Candidate-r18 ::= | SEQUENCE { |

| | |
|---|---|
| ltm-CandidateId-r18 | LTM-CandidateId-r18, |
| ltm-Config-r18 | OCTET STRING (CONTAINING RRCReconfiguration), |

| | |
|---|---|
| ltm-ConfigComplete-r18 | ENUMERATED {true} |

OPTIONAL -- Need R
...
}
LTM-CandidateResetL2-List-r18::= SEQUENCE (SIZE (1..maxNrofCellsLTM-r18)) OF
LTM-CandidateId-r18
Editor's Note: FFS on whether the LTM-CandidateNoResetL2-List field should include
separate reset flags for MAC, RLC, and PDCP recovery.
-- TAG-LTM-CANDIDATECONFIG-STOP
-- ASN1STOP

The ltm-Config field includes an RRCReconfiguration message used to configure an LTM candidate cell. This field shall include the CellGroupConfig IE, and it may also include the RadioBearerConfig IE, and MeasConfig IE. The ltm-ConfigComplete field indicates whether the LTM candidate cell configuration within ltm-Config is a complete configuration and thus the UE shall not use the LTM reference configuration within the field lte-ReferenceConfiguration. The ltm-CandidateNoResetL2-List field includes a list of LTM candidate cell identifiers for which the full L2 reset is needed upon an LTM cell switch. The ltm-ReferenceConfiguration field includes an RRCReconfiguration message used to configure a reference configuration for LTM. The FirstLTM-Candidate field is mandatorily present upon the first configuration of LTM-CandidateConfig. Otherwise, the field is optionally present, Need M.

### Ue Variables:

The IE VarLTM-Config is used to store the reference configuration and the LTM candidate cell configurations. The VarLTM-Config UE variable is as follows:

-- ASN1START
-- TAG-VARLTM-CONFIG-START
VarLTM-Config-r18-IEs ::= SEQUENCE {

| | |
|---|---|
| ltm-ReferenceConfiguration-r18 | OCTET STRING (CONTAINING |

RRCReconfiguration),

| | |
|---|---|
| ltm-CandidateList-r18 | LTM-CandidateList-r18 |
| ltm-CandidateResetL2-List-r18 | LTM-CandidateResetL2-List-r18 |

```
}
LTM-CandidateList-r18 ::= SEQUENCE (SIZE (1..maxNrofCellsLTM-r18)) OF LTM-
Candidate-r18
  LTM-CandidateResetL2-List-r18 ::= SEQUENCE (SIZE (1..maxNrofCellsLTM-r18)) OF
  LTM-Candidate-r18
  -- TAG-VARLTM-CONFIG-STOP
  -- ASN1STOP
```

### VarLTM-UE-Config:

The IE VarLTM-UE-Config is used to store the generated UE configuration related to the received LTM candidate cell configurations. The VarLTM-UE-Config UE variable is as follows:

-- ASN1START
-- TAG-VARLTM-CONFIG-START
VarLTM-UE-Config-r18-IEs ::= SEQUENCE {

| | |
|---|---|
| Ue-ltm-ConfigCandidateList-r18 | UE-LTM-ConfigCandidateList-r18 |

}
UE-LTM-ConfigCandidateList-r18 ::= SEQUENCE (SIZE (1..maxNrofCellsLTM-r18)) OF
UE-LTM-Config-r18

| | |
|---|---|
| UE-LTM-Candidate-r18 ::= | SEQUENCE { |
| ltm-CandidateId-r18 | LTM-CandidateId-r18, |

| | |
|---|---|
| ue-LTM-Config-r18 | OCTET STRING, |

}
-- TAG-VARLTM-CONFIG-STOP
-- ASN1STOP

LTM cell switch is supervised by a timer. This timer Tcellswitch is started, when the UE receives cell switch command and is stopped once the cell switch is completed. In an option, Tcellswitch is defined as a new timer. In another option, existing NR RRC timer T304 can be used for supervising LTM cell switch and all the embodiments for Tcellswitch as disclosed herein are applicable for T304 when it is used for LTM, such as supervising LTM cell switch. Tcellswitch may be described based on following characteristics:
1: The UE starts the Tcellswitch, upon reception of the LTM cell switch MAC CE;
2: The UE stops the Tcellswitch, upon successful completion of LTM cell switch;
3: If the Tcellswitch for MCG expires, the UE may declare LTM failure and initiate RRC re-establishment.
4. Tcellswitch is RRC layer timer

### Ltm Measurements:

A UE can be configured by the gNB with different measurement configurations for both layer 3 mobility (for example, using MeasConfig IE in R17 NR) and LTM. A UE which has been configured with measurement configurations for layer3 mobility (Measurements configured/performed/reported for layer 3 mobility; for example, configured through R17 MeasConfig IE in NR, is herein after referred as L3 measurements) and LTM (Measurements configured/performed/reported for LTM is herein after referred as LTM measurements), performs both L3 measurements and LTM measurements. LTM measurements are L1 measurements.

L1 measurement report for LTM is reported as periodic report on Physical Uplink Control Channel (PUCCH), semi-persistent report on PUCCH/Physical Uplink Shared Channel (PUSCH), and aperiodic report on PUSCH. Further, L1 measurements can be reported using MAC CE. The reports may be scheduled by gNB or initiated by UE. gNB can also decide for LTM through UL measurements.

### RRC Connection Re-Establishment:

RRC connection re-establishment procedure is used to re-establish the RRC connection. A UE in RRC_CONNECTED, for which AS security has been activated with SRB2 may send a RRC reestablishment request to gNB, and receive RRCReestablishment from gNB as specified in 3gpp TS 38.331 section 5.3.7. The UE may check the integrity of the message and send a RRC reestablishment complete message.

### RRC Resume:

A UE may move into a RRC_INACTIVE state upon receiving instructions from the network such as RRCRelease with suspend config. The UE stores the AS context in RRC_INACTIVE. A UE in RRC_INACTIVE moves to RRC_CONNECTED by sending a RRC message such as RRCResumeRequest or RRCResumeRequest1 in NR.

Further, the gNB may configure a UE to perform random access towards one or more LTM candidate cells for receiving Timing Advance (TA) before the cell switch is performed (known as Early TA). Random access performed on LTM candidate cells for the timing advance reception is known as random access for early TA. The gNB may send a Physical Downlink Control Channel (PDCCH) order to initiate a RACH for TA measurement for candidate cells. The UE receives the PDCCH order from the serving cell and upon reception of this PDCCH order, the UE initiates RACH for TA measurement for candidate cells on the one or more candidate cell. The UE may send RACH preamble to the candidate cells and receives the TA value from the candidate cell. The TA for candidate cells is received from a source cell. Generally, TA is received in the random access response, but TA may also be received through a MAC CE.

Further, Sidelink supports UE-to-UE direct communication using sidelink resource allocation modes, physical-layer signals/channels, and physical layer procedures below. The UE may perform NR sidelink discovery while in-coverage or out-of-coverage for non-relay operation. The Sidelink transmission and reception over the PC5 interface are supported when the UE is inside NG-RAN coverage, irrespective of which RRC state the UE is in, and when the UE is outside NG-RAN coverage.

For NR sidelink communication, the UE may operate in two modes. In one mode, a UE scheduled resource allocation is characterized by:
The UE needs to be RRC_CONNECTED in order to transmit data;
NG-RAN schedules transmission resources.

In another mode, UE autonomous resource selection is characterized by:
The UE can transmit data when inside NG-RAN coverage, irrespective of which Radio Resource Control (RRC) state the UE is in, and when outside NG-RAN coverage.

### Dual Connectivity:

Dual connectivity or more technically multi-radio dual connectivity is specified by 3GPP in specifications such as TS 37.340. A summary of the details on dual connectivity and measurement gap operations with dual connectivity are described. A Next Generation-Radio Access Network (NG-RAN) supports a Multi-Radio Dual Connectivity (MR-DC) operation whereby a UE in RRC_CONNECTED is configured to utilize radio resources provided by two distinct schedulers, located in two different NG-RAN nodes connected via a non-ideal backhaul, one providing NR (New Radio) access and the other one providing either E-UTRA (Evolved UMTS Terrestrial Radio Access) or NR access. One node acts as a Master Node (MN) and the other as a Secondary Node (SN). The MN and SN are connected via a network interface and at least the MN is connected to the core network. NG-RAN supports NG-RAN Evolved-UMTS Terrestrial Radio Access (E-UTRA)-NR Dual Connectivity (NGEN-DC), in which a UE is connected to one ng-eNB (a E-UTRA base station that can connect to 5G core) that acts as a MN and one gNB (5G base station) that acts as a SN. NG-RAN also supports NR-E-UTRA Dual Connectivity (NE-DC), in which a UE is connected to one gNB that acts as a MN and one ng-eNB that acts as a SN.

Thus, there exists a need for techniques to mitigate signalling overhead and latency issues that occur during a handover procedure.

Hence, there is a need in the art for solutions which will overcome the above mentioned drawback(s), among others.

The principal object of the embodiments herein is to disclose methods and systems for configuring and performing Lower-layer Triggered Mobility (LTM) in wireless communication networks for both a User Equipment (UE) and a network.

Another object of embodiments herein is to disclose methods for configuring and performing mobility in equivalent Stand-alone Non-Public Network (SNPN).

Another object of embodiments herein is to disclose methods for addressing a Centralized Unit (CU)-Distributed Unit (DU) (CU-DU) interaction for handling a reference configuration for LTM.

Another object of embodiments herein is to disclose methods for handling LTM configuration during a Radio Resource Control (RRC) reestablishment.

Another object of embodiments herein is to disclose methods for providing a Near Radio (NR) sidelink discovery procedure for a NR sidelink discovery reception in LTM candidate cell configuration.

Another object of embodiments herein is to disclose methods for providing interaction of a Master Node (MN) and a Secondary Node (SN) for a Random Access Channel (RACH) configuration for early Timing Advance (TA) acquisition.

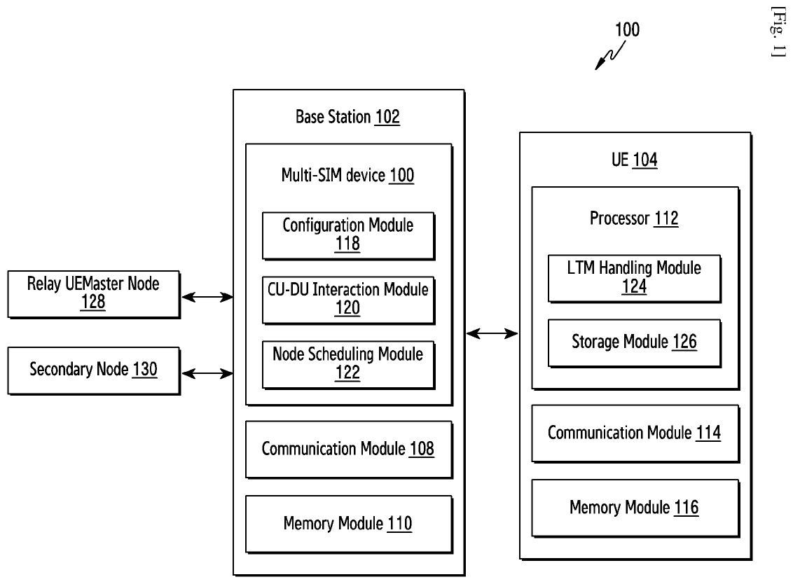

The embodiments herein provide methods and systems for configuring and performing Lower-layer Triggered Mobility (LTM) in wireless communication networks. Referring now to the drawings, and more particularly to FIGS. 1 through 9B, where similar reference characters denote corresponding features consistently throughout the figures, there are shown embodiments.

FIG. 1 depicts a system 100 for handling a LTM configuration. The system 100 comprises a base station 102, a User Equipment (UE) 104, a Master Node (MN) 128, and a Secondary Node (SN) 130. The base station 102 further comprises a processor 106, a communication module 108, and a memory module 110. The UE 104 further comprises a processor 112, a communication module 114, and a memory module 116.

In an embodiment herein, the processor 106 of the base station 102 can decide on configuring at least one neighbor cell as one of a candidate cell for the LTM, a target cell for a Layer (L3) handover, and a candidate cell for a conditional handover. The processor 106 of the base station 102 further comprises a configuration module 118, a Centralized Unit-Distributed Unit (CU-DU) interaction module 120, and a node scheduling module 122.

In an embodiment herein, the configuration module 118 can receive at least one neighbor cell measurement from the UE 104. The configuration module 118 can identify at least one neighbor cell as a candidate cell or a target cell, based on the received neighbor cell measurement. The configuration module 118 can identify the neighbor cell as one of a candidate cell for a LTM, a target cell for a Layer3 (L3) handover, and a candidate cell for a conditional handover. The configuration module 118 can verify if the identified neighbor cell supports a serving Stand-alone Non-Public Network (SNPN) ID or an SNPN ID of an equivalent SNPN. The configuration module 118 can configure the neighbor cell as one of the candidate cell for the LTM, the target cell for L3 handover, and the candidate cell for the conditional handover, if the neighbor cell supports the serving SNPN ID or the SNPN ID of an equivalent SNPN. Further, the configuration module 118 can skip configuration of the neighbor cell, if the neighbor cell does not support the serving SNPN ID or the SNPN ID of an equivalent SNPN. In an embodiment herein, the configuration module 118 can configure the UE 104 with at least one sidelink pool of resources for the configured neighbor cell for performing a New Radio (NR) sidelink discovery reception in the LTM configuration. The configuration module 118 can add a Physical Uplink Control Channel (PUCCH) configuration in the LTM configuration for the configured neighbor cell. In an embodiment herein, the configuration module 118 can remove the PUCCH configuration in the LTM configuration for the configured neighbor cell.

In an embodiment herein, the CU-DU interaction module 120 can select a Centralized Unit (CU) of the base station 102 of the configured neighbor cell, to send a reference configuration of the LTM to a Distributed Unit (DU) of the base station 102 for performing the LTM configuration. The CU of the base station 102 sends the reference configuration in at least one of a UE context setup request message, and a UE context modification request message. In an embodiment herein, the CU of the base station 102 of the configured neighbor cell can send a release request to the DU of the base station 102 to release the reference configuration of the LTM. The CU of the base station 102 sends the release request in at least one of the UE context setup request message, and the UE context modification request message. In an embodiment herein, the CU of the base station 102 of the configured neighbor cell can send a modify request to the DU of the base station 102 to modify the reference configuration of the LTM. The CU of the base station 102 sends the modify request in at least one of the UE context setup request message, and the UE context modification request message.

In an embodiment herein, the node scheduling module 122 can communicate with the MN 128, and the SN 130 for scheduling the UE 104 to send at least one of a Downlink (DL) data, and a control message. The control message can be a MAC Control Element (MAC CE) in NR or the PDCCH (Physical Downlink Control Channel) information. In an embodiment herein, the MN 128 does not schedule the UE 104 to send at least one of the DL data, and the control message during the time when the UE 104 is sending one or more Random Access Channel (RACH) preambles in another frequency for early Timing Advance (TA) acquisition as triggered by the MN 128. In an embodiment herein, the SN 130 does not schedule the UE 104 to send at least one of the DL data, and the control message during the time when the UE 104 is sending one or more RACH preambles in another frequency for early TA acquisition as triggered by the SN 130.

In an embodiment herein, the processor 112 of the UE 104 can remove entries of one or more UE configurations on receiving at least one configured LTM candidate cell of the LTM configuration. The processor 112 of the UE 104 further comprises LTM handling module 124, and a storage module 126.

In an embodiment herein, the LTM handling module 124 can receive at least one configured LTM candidate cell of the LTM configuration from the base station 102. The LTM handling module 124 can remove entries of one or more UE configurations for at least one of a Master Cell Group (MCG), and a Secondary Cell Group (SCG), after receiving the configured LTM candidate cell of the LTM configuration. The LTM handling module 124 can remove entries of the UE configurations within at least one UE variable for at least one of the MCG, and the SCG. The removal of the UE configurations is performed following cell selection while timer T311 is running. The UE configurations can be, but not limited to, at least one of an early RACH configuration, and a Transmission Configuration Indicator (TCI) state configuration. The removal of the UE configurations following cell selection while timer T311 is running is skipped if the UE 104 is informed by a network that the UE 104 is allowed to perform LTM execution on detecting at least one of a Radio Link failure (RLF), and a LTM execution failure. In an embodiment herein, the LTM handling module 124 can remove the entries of the UE configurations, upon the UE 104 moving to a Radio Resource Control (RRC) IDLE state. In an embodiment herein, the LTM handling module 124 can remove the entries of the UE configurations, upon the UE 104 receiving a RRC release request including a suspend configuration. In an embodiment herein, the LTM handling module 124 can remove the entries of the UE configurations within the UE variable for handling of a RACH configuration for early TA during the RRC reestablishment procedure. The UE 104 performs a random access for early TA acquisition on Secondary Cells (Scells) for one or more LTM candidate cells. In an embodiment herein, the LTM handling module 124 can remove the UE configurations of one or more Transmission Configuration Indicator (TCI) states for the LTM candidate cells during the RRC reestablishment procedure.

In an embodiment herein, the storage module 126 can store the configured LTM candidate cell in the UE variable during an RRC reestablishment procedure, after removing the entries of the UE configurations.

In an embodiment herein, the processor 106, and the processor 112 can process and execute data of a plurality of modules of the base station 102 and the UE 104 respectively. The processor 106, and the processor 112 can be configured to execute instructions stored in the memory module 110, and the memory module 116 respectively. The processor 106, and the processor 112 may comprise one or more of microprocessors, circuits, and other hardware configured for processing. The processor 106, and the processor 112 can be at least one of a single processer, a plurality of processors, multiple homogeneous or heterogeneous cores, multiple Central Processing Units (CPUs) of different kinds, microcontrollers, special media, and other accelerators. The processor 106, and the processor 112 may be an application processor (AP), a graphics-only processing unit (such as a graphics processing unit (GPU), a visual processing unit (VPU)), and/or an Artificial Intelligence (AI)-dedicated processor (such as a neural processing unit (NPU)).

In an embodiment herein, the plurality of modules of the processor 106 of the base station 102, and the processor 112 of the UE 104 can communicate via the communication module 108, and the communication module 114 respectively. The communication module 108, and the communication module 114 may be in the form of either a wired network or a wireless communication network module. The wireless communication network may comprise, but not limited to, Global Positioning System (GPS), Global System for Mobile Communications (GSM), Wi-Fi, Bluetooth low energy, Near-field communication (NFC), and so on. The wireless communication may further comprise one or more of Bluetooth, ZigBee, a short-range wireless communication (such as Ultra-Wideband (UWB)), and a medium-range wireless communication (such as Wi-Fi) or a long-range wireless communication (such as 3G/4G/5G/6G and non-3GPP technologies or WiMAX), according to the usage environment.

In an embodiment herein, the memory module 110, and the memory module 116 may comprise one or more volatile and non-volatile memory components which are capable of storing data and instructions of the modules of the base station 102, and the UE 104 to be executed. Examples of the memory module 110, and the memory module 116 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 110, and the memory module 116 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 110, and the memory module 116 may, in some examples, be considered a non-transitory storage medium. The term “non-transitory” may indicate that the storage medium is not embodied in a carrier wave or a propagated signal. However, the term “non-transitory” should not be interpreted to mean that the memory module 110, and the memory module 116 is non-movable. In certain examples, a non-transitory storage medium may store data that can, over time, change (for example, in Random Access Memory (RAM) or cache).

FIG. 1 shows example modules of the base station 102, and the UE 104 respectively, but it is to be understood that other embodiments are not limited thereon. In other embodiments, the base station 102, and the UE 104 may include less or more number of modules. Further, the labels or names of the modules are used only for illustrative purpose and does not limit the scope of the invention. One or more modules can be combined together to perform same or substantially similar function in the base station 102, and the UE 104 respectively.

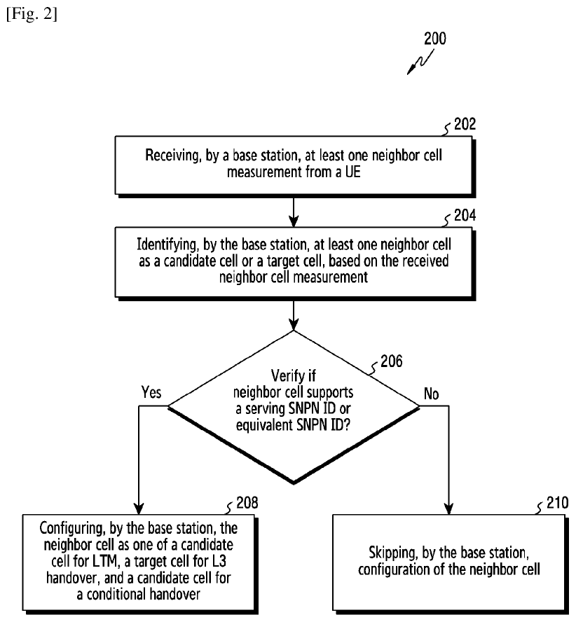

FIG. 2 depicts a method 200 for handling the LTM configuration. The method 200 comprises receiving, by the base station 102, at least one neighbor cell measurement from the UE 104, as depicted in step 202. The method 200 comprises identifying, by the base station 102, at least one neighbor cell as a candidate cell or a target cell, based on the received neighbor cell measurement, as depicted in step 204. The base station 102 identifies the neighbor cell as one of a candidate cell for a LTM, a target cell for a L3 handover, and a candidate cell for a conditional handover. The base station may also identify the neighbor cell as a candidate cell for a LTM a target cell for a L3 handover, and a candidate cell for a conditional handover based on other methods, for e.g. based on the need for load balancing or based on its own internal measurements.

Thereafter, the method 200 comprises verifying, by the base station 102, if the identified neighbor cell supports a serving SNPN ID or an SNPN ID of an equivalent SNPN, as depicted in step 206. The method 200 comprises configuring, by the base station 102, the neighbor cell as one of the candidate cell for the LTM, the target cell for L3 handover, and the candidate cell for the conditional handover, if the neighbor cell supports the serving SNPN ID or the SNPN ID of an equivalent SNPN, as depicted in step 208. Later, the method 200 comprises skipping, by the base station 102, configuration of the neighbor cell, if the neighbor cell does not support the serving SNPN ID or the SNPN ID of an equivalent SNPN, as depicted in step 210.

The various actions in method 200 may be performed in the order presented, in a different order or simultaneously. Further, in some embodiments, some actions listed in FIG. 2 may be omitted.

FIG. 3 depicts a method 300 for handling UE configurations based on a RLF or LTM execution failure. The method 300 comprises receiving, by the UE 104, at least one configured LTM candidate cell of the LTM configuration from the base station 102, as depicted in step 302. The method 300 comprises detecting, by the UE 104, a RLF or LTM execution failure, as depicted in step 304, after receiving the configured LTM candidate cell of the LTM configuration.

The method 300 comprises checking, by the UE 104, if the UE 104 is informed by a network that the UE 104 is allowed to perform LTM execution, as depicted in step 306. The method 300 comprises removing, by the UE 104, configured LTM candidate cells of the LTM configuration, as depicted in step 308, if the UE 104 is informed by the network that the UE 104 is not allowed to perform LTM execution

Thereafter, the method 300 comprises keeping, by the UE 104, configured LTM candidate cells of the LTM configuration, as depicted in step 310, if the UE 104 is informed by the network that the UE 104 is allowed to perform LTM execution

The various actions in method 300 may be performed in the order presented, in a different order or simultaneously. Further, in some embodiments, some actions listed in FIG. 3 may be omitted.

### Handling of Generated UE Configuration:

In an embodiment herein, the UE 104 removes all entries within the UE variable for storing generated UE configuration for LTM (such as, but not limited to, VarLTM-UE-Config) during a RRC reestablishment procedure. The RRC Reestablishment procedure includes various steps as detailed in 3GPP TS 38.331 section 5.3.7.

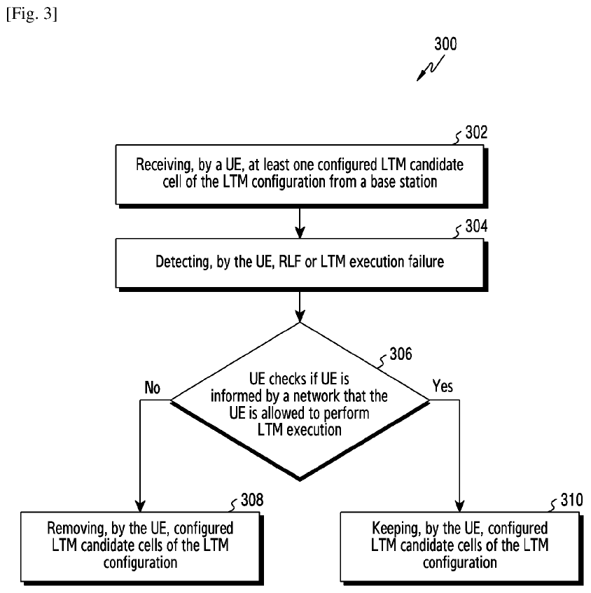

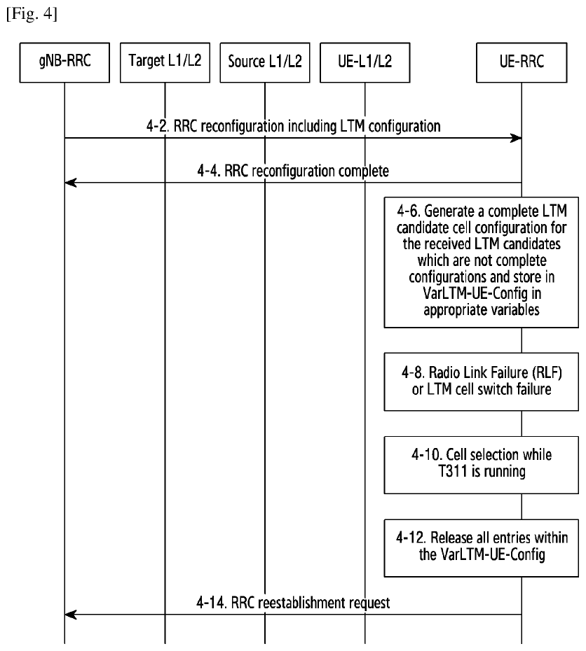

FIG. 4 depicts a process of handling generated LTM configurations during a RRC reestablishment. As depicted in step 4-2, an RRC reconfiguration including LTM configuration message is transmitted from a gNB-RRC to a UE-RRC. A RRC reconfiguration complete message is sent from the UE-RRC to the gNB-RRC, as depicted in step 4-4, in response to the RRC reconfiguration message. Later, UE-RRC generates a complete LTM candidate cell configuration for the received LTM candidates which are not complete configurations, and stores the generated LTM candidate cell configuration in appropriate variables (VarLTM-UE-Config), as depicted in step 4-6.

Thereafter, an RLF or LTM cell switch failure is occurred at UE-RRC, as depicted in step 4-8. The RLF or LTM cell switch failure is occurred following a cell selection while T311 is running, as depicted in step 4-10. The UE-RRC releases all entries within the VarLTM-UE-Config, as depicted in step 4-12. Later, an RRC reestablishment request is sent from the UE-RRC to the gNB-RRC, as depicted in step 4-14.

In an embodiment herein, the UE 104 removes the stored generated UE configuration related to the received LTM candidate cell configurations for LTM (such as, but not limited to, VarLTM-UE-Config) during a RRC reestablishment procedure. Embodiments herein use the term VarLTM-UE-Config to refer to the UE variable for storing the generated UE configuration for LTM (such as, but not limited to, the stored UE configuration related to the received LTM candidate cell configurations for LTM).

In an embodiment herein, the UE 104 removes all entries within VarLTM-UE-Config for MCG during a RRC reestablishment procedure. In an embodiment herein, the UE 104 removes all entries within VarLTM-UE-Config for MCG during a RRC reestablishment procedure, but keeps all entries in VarLTM-UE-Config for SCG. In an embodiment herein, the UE 104 removes all entries within VarLTM-UE-Config for both MCG and SCG during a RRC reestablishment procedure.

In an embodiment herein, the UE 104 removes all entries within the VarLTM-UE-Config following a cell selection while T311 is running, or alternatively, the removal can be performed following cell selection, while a RLF is detected or upon the reception of RRC reestablishment. In an embodiment herein, the UE 104 removes all entries within the VarLTM-UE-Config for MCG following a cell selection while T311 is running, or alternatively, the removal can be performed following cell selection, while a RLF is detected or upon the reception of RRC reestablishment. In an embodiment herein, the UE 104 removes all entries within the VarLTM-UE-Config for both MCG and SCG following a cell selection while T311 is running, or alternatively, the removal can be performed following cell selection, while a RLF is detected or upon the reception of a RRC reestablishment.

In an alternative embodiment, the UE 104 keeps all entries within the VarLTM-UE-Config during a RRC reestablishment procedure. In an alternative embodiment, the UE 104 keeps all entries within the VarLTM-UE-Config during a cell selection while T311 is running. In an alternative embodiment, the UE 104 keeps all entries within the VarLTM-UE-Config while sending a request for a RRC reestablishment such as sending NR RRC reestablishment request message. In an alternative embodiment, the UE 104 keeps all entries within the VarLTM-UE-Config, while receiving a message for RRC reestablishment such as sending NR RRC reestablishment message. In an alternative embodiment, the UE 104 removes all entries within the VarLTM-UE-Config while receiving a message for RRC setup such as NR RRCSetup after sending a request for RRC reestablishment such as sending a NR RRC reestablishment request message.

5.3.7.3 Actions Following Cell Selection while T311 is Running:

Upon selecting a suitable NR cell, the UE shall:
1> ensure having valid and up to date essential system information as specified in clause 5.2.2.2;
1> stop timer T311;
1> if T390 is running:
2> stop timer T390 for all access categories;
2> perform the actions as specified in 5.3.14.4;
1> remove all the entries within the MCG VarLTM-UE-Config, if any;

In an embodiment herein, the UE 104 removes all entries within the VarLTM-UE-Config upon moving to a RRC_IDLE state. In an embodiment herein, the UE 104 removes all entries within the VarLTM-UE-Config upon releasing a RRC connection. In an embodiment herein, the UE 104 removes all entries within the VarLTM-UE-Config upon moving to another Radio Access Technology (RAT). In an embodiment herein, the UE 104 removes all entries within the VarLTM-UE-Config upon moving to another RAT from NR. In an embodiment herein, the UE 104 removes all entries within the VarLTM-UE-Config upon moving to LTE from NR. In an embodiment herein, the UE 104 removes all entries within the VarLTM-UE-Config upon performing SRVCC to UTRA.

In an embodiment herein, on receiving a RRC release or RRC release with suspend config, the UE 104 removes all entries within the VarLTM-UE-Config. As per this embodiment, the UE 104 removes all entries within the VarLTM-UE-Config while moving to RRC_INACTIVE. In an embodiment herein, the UE 104 stores the configuration during RRC Release with suspend config and further removes all entries within the VarLTM-UE-Config during a RRC resume procedure (RRC Resume procedure includes the various steps as detailed in 3GPP TS 38.331 section 5.7.3).

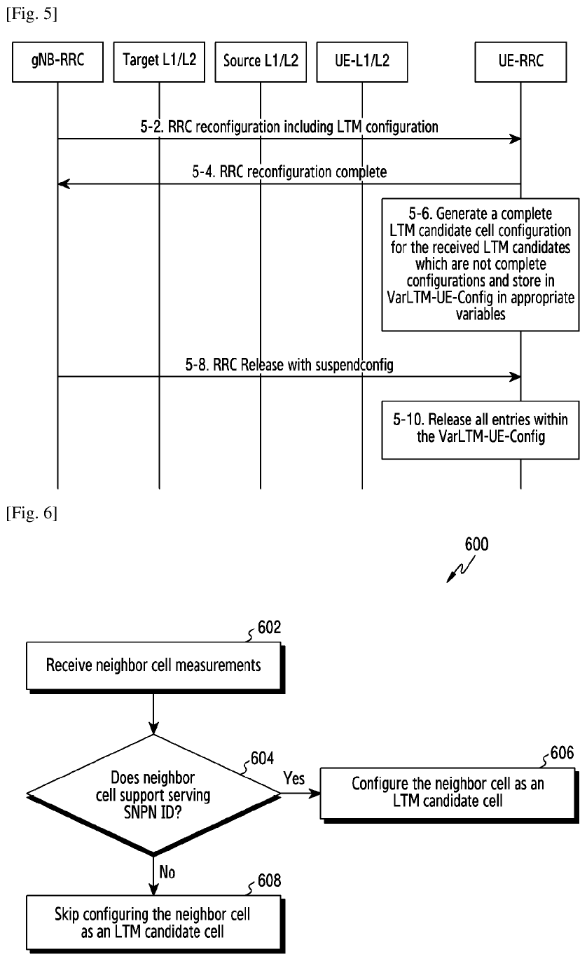

FIG. 5 depicts a process of handling a generated LTM configuration for RRC resume. As depicted in step 5-2, an RRC reconfiguration including LTM configuration message is transmitted from a gNB-RRC to a UE-RRC. A RRC reconfiguration complete message is sent from the UE-RRC to the gNB-RRC, as depicted in step 5-4, in response to the RRC reconfiguration message. Later, UE-RRC generates a complete LTM candidate cell configuration for the received LTM candidates which are not complete configurations, and stores the generated LTM candidate cell configuration in appropriate variables (VarLTM-UE-Config), as depicted in step 5-6.

Thereafter, a RRC release message with suspendconfig is sent from the gNB-RRC to the UE-RRC, as depicted in step 5-8. The UE-RRC releases all entries within the VarLTM-UE-Config, as depicted in step 5-10, based on the received RRC release message.

In an embodiment herein, the UE 104 removes all entries within the VarLTM-UE-Config for SCG during a SCG release. In an embodiment herein, at RLF or LTM execution failure (for MCG), the UE 104 performs fast recovery to a candidate cell by LTM execution. The UE 104 may be informed by the network whether the network can perform LTM execution upon RLF or LTM execution failure for MCG. In an embodiment herein, this information is provided per candidate cell. The UE 104 may be configured by a flag which indicates if the UE 104 can perform a LTM execution upon RLF or LTM execution failure for MCG. In an embodiment herein, this flag is provided per candidate cell. If the UE 104 selects a candidate cell, and if the UE 104 is configured to perform LTM execution upon RLF or LTM execution failure (for this candidate cell, if this configuration is per candidate cell), then the UE 104 executes LTM cell switch on that candidate cell.

FIG. 6 depicts a flow process 600 for performing a LTM candidate cell configuration for a Non-Public Network (NPN). As depicted in step 602, the base station 102 receives neighbor cell measurements from the UE 104. The base station 102 verifies if the neighbor cell supports a serving SNPN ID or an equivalent SNPN ID, as depicted in step 604. If the neighbor cell supports the serving SNPN ID or an equivalent SNPN ID, then the base station 102 configures the neighbor cell as an LTM candidate cell, as depicted in step 606. If the neighbor cell does not support the serving SNPN ID or an equivalent SNPN ID, then the base station 102 skips configuring the neighbor cell as an LTM candidate cell, as depicted in step 608.

The various actions in flow process 600 may be performed in the order presented, in a different order or simultaneously. Further, in some embodiments, some actions listed in FIG. 6 may be omitted.

If the UE 104 is informed by the network that the UE 104 can perform a LTM execution upon a RLF or LTM execution failure, then the UE 104 skips clearing the VarLTM-UE-Config.

VarLTM-UE-Config is an example name for the UE storage and the UE may use alternate variable names or may not assign a specific name for UE storage which stores the generated LTM configuration.

### Handling of VarLTM-Config:

In an embodiment herein, the UE 104 removes all entries within the VarLTM-Config (VarLTM-Config as explained in background) during a RRC Reestablishment.

In an embodiment herein, the UE 104 removes all entries within the VarLTM-Config following a cell selection while T311 is running, or alternatively, the removal can be performed following cell selection, while a RLF is detected or upon reception of a RRC reestablishment. In an embodiment herein, the UE 104 removes all entries within the VarLTM-Config for MCG following a cell selection while T311 is running, or alternatively, the removal can be performed following the cell selection, while a RLF is detected or upon reception of the RRC reestablishment. In an embodiment herein, the UE 104 removes all entries within the VarLTM-Config for MCG during the RRC reestablishment procedure, but keeps all entries in VarLTM-Config for SCG. In an embodiment herein, the UE 104 removes all entries within the VarLTM-Config for both MCG and SCG following a cell selection while T311 is running, or alternatively, the removal can be performed following the cell selection, while a RLF is detected or upon reception of the RRC reestablishment. VarLTM-Config is an example name for the UE storage and the UE may use alternate variable names or may not assign a specific name for UE storage which stores the received LTM configuration.

### Handling of RACH Configuration for Early TA:

In an embodiment herein, the UE 104 removes all the configuration for handling of RACH configuration for early TA during a RRC reestablishment. In an embodiment herein, the UE 104 removes all the configuration for handling of RACH configuration for early TA following a cell selection while T311 is running, or alternatively, the removal can be performed following the cell selection, while a RLF is detected or upon reception of the RRC reestablishment. In an embodiment herein, on receiving a RRC release or RRC release with suspend config, the UE 104 removes all the configuration for handling of RACH configuration for early TA.

### Handling of TCI States for LTM Candidate Cells:

In an embodiment herein, the UE 104 removes all the configurations of TCI states for the LTM candidate cells during a RRC reestablishment. In an embodiment herein, the UE 104 removes all the configurations of TCI states for the LTM candidate cells following a cell selection while T311 is running, or alternatively, the removal can be performed following the cell selection, while a RLF is detected or upon reception of the RRC reestablishment. In an embodiment herein, on receiving a RRC release or RRC Release with suspend config, the UE 104 removes all the configurations of TCI states for the LTM candidate cells.

### Handling of LTM for NPN:

In an embodiment herein, a source gNB avoids configuring the cells that do not support the serving SNPN ID as LTM candidate cells. In an embodiment herein, the source gNB avoids configuring the cells that do not support the serving SNPN ID or equivalent SNPN IDs as LTM candidate cells.

In an embodiment herein, a source base station (gNB) avoids configuring the cells that do not support the serving SNPN ID or the equivalent SNPN IDs as candidate cells for L3 mobility.

In an embodiment herein, a target gNB performs access control including checks for SNPN. If the target gNB does not support the serving SNPN ID or the equivalent SNPN IDs, the target gNB fails the handover or LTM candidate cell configuration.

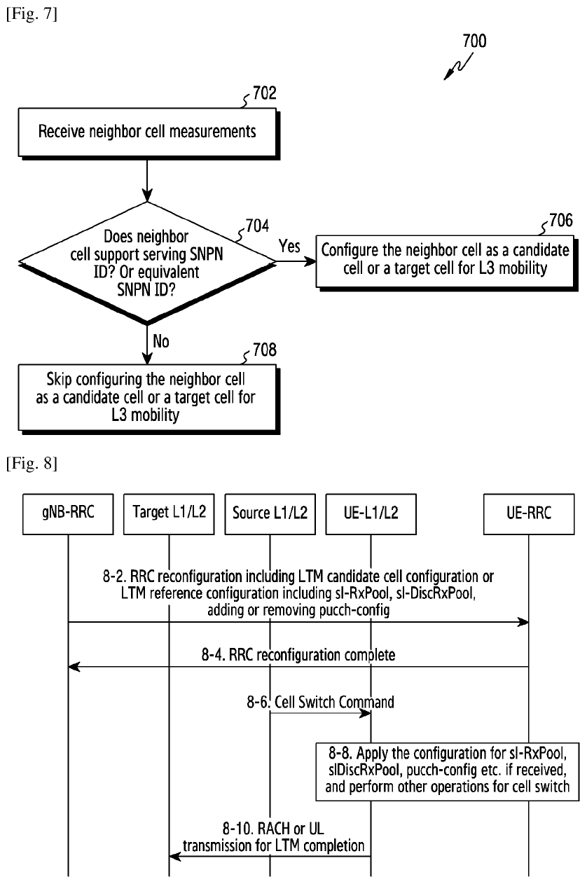

FIG. 7 depicts a flow process 700 of performing L3 mobility candidate cell/target cell configuration for NPN with equivalent SNPN. As depicted in step 702, the base station 102 receives neighbor cell measurements from the UE 104. The base station 102 verifies if the neighbor cell supports a serving SNPN ID or an equivalent SNPN ID, as depicted in step 704. If the neighbor cell supports the serving SNPN ID or the equivalent SNPN ID, then the base station 102 configures the neighbor cell as a candidate cell or a target cell for L3 mobility, as depicted in step 706. If the neighbor cell does not support the serving SNPN ID or the equivalent SNPN ID, then the base station 102 skips configuring the neighbor cell as a candidate cell or a target cell for L3 mobility, as depicted in step 708.

The various actions in flow process 700 may be performed in the order presented, in a different order or simultaneously. Further, in some embodiments, some actions listed in FIG. 7 may be omitted.

### T321/T322 Handling and LTM:

In an embodiment herein, upon executing a cell switch (for example, UE RRC executes cell switch upon receiving an indication from lower layers that cell switch command is received or based on some condition for executing LTM is satisfied), the UE 104 stops a periodical reporting timer, timer T321 or timer T322, if running (as defined or described in TS 38.331 v17.2.0).

### gNB CU-DU Interaction for Reference Configuration:

In an embodiment herein, gNB CU (or the centralized unit of the base station 102) sends a reference configuration to be used for LTM to a gNB DU (or the distributed unit of the base station 102) in F1 Application Protocol (F1AP) F1AP messages. In an embodiment herein, gNB CU (or the centralized unit of the base station 102) sends (or sets up) the reference configuration to be used for LTM to the gNB DU (or the distributed unit of the base station 102) in a F1AP UE context setup request message. In an embodiment herein, gNB CU (or the centralized unit of the base station 102) sends (or sets up) the reference configuration to be used for LTM to the gNB DU (or the distributed unit of the base station 102) in a F1AP UE context modification request message.

In an embodiment herein, the gNB CU (or the centralized unit of the base station 102) requests the gNB DU to release the reference configuration to be used for LTM (or the distributed unit of the base station 102) in a F1AP message. In an embodiment herein, gNB CU (or the centralized unit of the base station 102) requests the gNB DU to release the reference configuration to be used for LTM (or the distributed unit of the base station 102) in a F1AP UE context modification request message. In an embodiment herein, the gNB CU (or the centralized unit of the base station 102) sends the reference configuration to be used for LTM to the gNB DU (or the distributed unit of the base station 102) in a F1AP UE context modification request message.

In an embodiment herein, the gNB CU (or the centralized unit of the base station 102) requests the gNB DU to modify the reference configuration to be used for LTM (or the distributed unit of the base station 102) in a F1AP message. In an embodiment herein, the gNB CU (or the centralized unit of the base station 102) requests the gNB DU to modify the reference configuration to be used for LTM (or the distributed unit of the base station 102) in a F1AP UE context modification request message.

In various embodiments herein, interactions for sidelink, and Physical Uplink Control Channel (PUCCH) configuration during configuration of LTM candidate cell and reference configurations is disclosed. Further, MN-SN interaction for LTM is disclosed, especially when RACH for early TA is configured.

In an embodiment herein, a method for a sidelink configuration and LTM is disclosed. In the present disclosure, all the embodiments for gNB 102 are applicable for any Radio Access Network Node (for example, a 6G base station) and the gNB 102 may configure the UE 104 with sl-RxPool in LTM candidate cell configuration or reference configuration. This may lead to below example changes in the TS 38.331 specification.

A UE capable of NR sidelink communication that is configured by upper layers to receive NR sidelink communication shall:
1> if the conditions for NR sidelink communication operation as defined in 5.8.2 are met:
2> if the frequency used for NR sidelink communication is included in sl-FreqInfoToAddModList in RRCReconfiguration message or sl-FreqInfoList included in SIB12:
3> if the UE is configured with sl-RxPool included in RRCReconfiguration message with reconfiguration WithSync (i.e., handover) or LTM candidate cell configuration or LTM Reference configuration:
4> configure lower layers to monitor sidelink control information and the corresponding data using the pool of resources indicated by sl-RxPool;
3> else if the cell chosen for NR sidelink communication provides SIB12:
4> configure lower layers to monitor sidelink control information and the corresponding data using the pool of resources indicated by sl-RxPool in SIB12; 2> else:
3> configure lower layers to monitor sidelink control information and the corresponding data using the pool of resources that were preconfigured by sl-RxPool in SL-PreconfigurationNR, as defined in clause 9.3;

In an alternate embodiment, the gNB 102 may skip configuring the UE 104 with sl-RxPool in LTM candidate cell configuration or LTM Reference configuration.

In an embodiment herein, a method for performing a sidelink discovery is disclosed. The gNB 102 may configure the UE 104 with a sl-RxPool for NR sidelink discovery reception in a LTM candidate cell configuration. In an alternate embodiment herein, the gNB 102 may configure the UE 104 with a sl-RxPool for NR sidelink discovery reception in a LTM reference configuration. In an embodiment herein, the gNB 102 may configure the UE 104 with a sl-DiscRxPool for NR sidelink discovery reception in LTM candidate cell configuration. In an alternate embodiment herein, the gNB 102 may configure the UE 104 with a sl-DiscRxPool for a NR sidelink discovery reception in a LTM reference configuration.

In one embodiment herein, the NR sidelink discovery procedure is performed as in the below embodiments with reference to TS 38.331.

FIG. 8 depicts a sequence diagram for configuring LTM for NR sidelink discovery and PUCCH configuration. As depicted in step 8-2, the gNB-RRC sends a RRC reconfiguration message including LTM candidate cell configuration or LTM reference configuration, to the UE-RRC. The RRC reconfiguration message includes sl-RxPool, sl-DiscRxPool, and adding or removing of pucch-config. The UE-RRC completes configuration and sends an RRC reconfiguration complete message to the gNB-RRC, as depicted in step 8-4.

Thereafter, a cell switch command is sent from a source Layer1 (L1)/Layer2 (L2) to a UE L1/L2, as depicted in step 8-6. The UE L1/L2 applies the configuration for sl-RxPool, sl-DiscRxPool, pucch-config etc. if received, and performs other operations for cell switch, as depicted in step 8-8. Later, after completion of the configuration, a RACH or UL transmission for LTM completion is transmitted from the UE-L1/L2 to a target cell L1/L2, as depicted in step 8-10.

### 5.8.13 NR Sidelink Discovery

### 5.8.13.1 General

The purpose of this procedure is to perform a NR sidelink discovery as specified in TS 23.304 [65].

5.8.13.2 NR Sidelink Discovery Monitoring

a UE Capable of NR Sidelink Discovery that is Configured by Upper Layers to Monitor NR sidelink discovery messages shall:
1> if the frequency used for NR sidelink discovery is included in sl-FreqInfoToAddModList in RRCReconfiguration message and sl-DiscConfig is included in RRCReconfiguration; or if the frequency used for NR sidelink discovery is included in sl-FreqInfoList included in SIB12 and sl-DiscConfigCommon is included in SIB12:
2> if the UE is configured with sl-DiscRxPool for NR sidelink discovery reception included in RRCReconfiguration message with reconfiguration WithSync (i.e., handover) or LTM candidate cell configuration or LTM reference configuration:
3> configure lower layers to monitor sidelink control information and the corresponding data using the resource pool indicated by sl-DiscRxPool for NR sidelink discovery reception in RRCReconfiguration;
2> else if the UE is configured with sl-RxPool for NR sidelink discovery reception included in RRCReconfiguration message with reconfiguration WithSync (i.e., handover) or LTM candidate cell configuration or LTM reference configuration

In an alternate embodiment herein, the gNB 102 may skip configuring the UE 104 with sl-RxPool for NR sidelink discovery reception in LTM candidate cell configuration. In an alternate embodiment herein, the gNB 102 may skip configuring the UE 104 with sl-RxPool for NR sidelink discovery reception in LTM reference configuration.

In another alternate embodiment herein, the gNB 102 may skip configuring the UE 104 with sl-DiscRxPool for NR sidelink discovery reception in LTM candidate cell configuration. In an alternate embodiment herein, the gNB 102 may skip configuring the UE 104 with sl-DiscRxPool for NR sidelink discovery reception in LTM reference configuration.

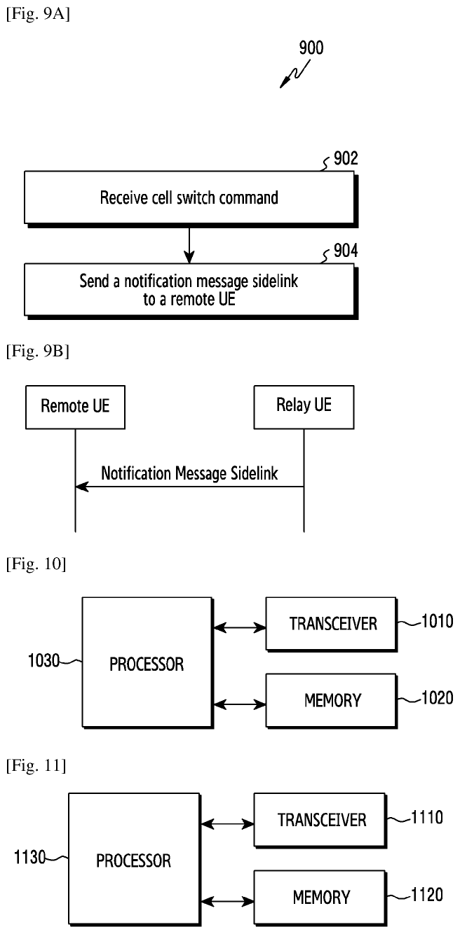

FIG. 9A depicts a method 900 for sending a notification message in a sidelink. The method 900 comprises receiving a cell switch command by a relay UE from a remote UE, as depicted in step 902. Thereafter, the method 900 comprises sending, by the relay UE, a notification message sidelink to the remote UE, as depicted in step 904.

The various actions in method 900 may be performed in the order presented, in a different order or simultaneously. Further, in some embodiments, some actions listed in FIG. 9A may be omitted.

FIG. 9B depicts a sequence diagram of receiving the notification message in sidelink. According to FIG. 9B, the U2N relay UE may send notification to connected U2N remote UE during a cell switch procedure. This may lead to below example changes in the TS 38.331 specification.

### 5.8.9.10 Notification Message

### 5.8.9.10.1 General

This procedure is used by a U2N Relay UE to send notification to the connected U2N Remote UE.

### 5.8.9.10.2 Initiation

The U2N Relay UE may initiate the procedure when one of the following conditions is met:
1> upon Uu RLF as specified in 5.3.10;
1> upon reception of an RRCReconfiguration including the reconfiguration WithSync or cell switch command or execution off cell switch procedure (such as upon satisfying the conditions for conditional LTM);
1> upon cell reselection;

In an alternate embodiment herein, the U2N relay UE or U2N remote UE may not be configured for LTM by network node such as gNB 102. In an alternate embodiment, the U2N relay UE or U2N remote UE may not be configured with a LTM candidate cell configuration and LTM reference configuration by network node such as gNB 102.

### Uplink Dedicated BWP Configuration

In an embodiment herein, the network (such as gNB 102) may add or remove the PUCCH configuration (such as pucch-Config in NR) in a LTM candidate cell configuration (for a Special Cell (SpCell) or PUCCH Secondary Cell (SCell)) and avoid adding the same in a LTM reference configuration (for SpCell or PUCCH SCell).

In an embodiment herein, the network (such as gNB 102) may add the PUCCH configuration (such as pucch-Config in NR) in LTM candidate cell configuration (for SpCell or PUCCH SCell). In an embodiment herein, the network (such as gNB 102) may remove the PUCCH configuration (such as pucch-Config in NR) in a LTM candidate cell configuration (for SpCell or PUCCH SCell).

In an embodiment herein, the network (such as gNB 102) may add the PUCCH configuration (such as pucch-Config in NR) in LTM reference configuration (for SpCell or PUCCH SCell). In an embodiment herein, the network (such as gNB 102) may remove the PUCCH configuration (such as pucch-Config in NR) in LTM reference configuration (for SpCell or PUCCH SCell). In an alternate embodiment herein, the gNB 102 may avoid adding or removing the PUCCH configuration (such as pucch-Config in NR) in LTM candidate cell configuration (for SpCell or PUCCH SCell.

In an alternate embodiment herein, the gNB 102 may avoid adding or removing the PUCCH configuration (such as pucch-Config in NR) in LTM reference configuration (for SpCell or PUCCH SCell. In an embodiment herein, the network (such as gNB 102) may add the PUCCH configuration (such as pucch-Config in NR) in LTM candidate cell configuration or LTM reference configuration (for SpCell or PUCCH SCell), if the cell switch does not perform Layer 2 reset such as MAC reset. In an embodiment herein, the network (such as gNB 102) may remove the PUCCH configuration (such as pucch-Config in NR) in a LTM candidate cell configuration or a LTM reference configuration (for SpCell or PUCCH SCell), if the cell switch does not perform Layer 2 reset such as MAC reset.

In an embodiment herein, the network (such as gNB 102) may add the PUCCH configuration (such as pucch-Config in NR) in LTM candidate cell configuration (for SpCell or PUCCH SCell), if the LTM candidate cell configuration is a complete configuration. In an embodiment herein, the network (such as gNB 102) removes the PUCCH configuration (such as pucch-Config in NR) in LTM candidate cell configuration (for SpCell or PUCCH SCell), if the LTM candidate cell configuration is a complete configuration. Some of the embodiments disclosed may be captured as below in TS 38.331.
Bandwidth Part (BWP)-UplinkDedicated

The IE BWP-UplinkDedicated is used to configure the dedicated (UE specific) parameters of an uplink BWP. BWP-UplinkDedicated information element is given as below

-- ASN1START
-- TAG-BWP-UPLINKDEDICATED-START

| | |
|---|---|
| BWP-UplinkDedicated ::= | SEQUENCE { |

| | | |
|---|---|---|
| pucch-Config | SetupRelease { PUCCH-Config } | OPTIONAL, |

-- Need M

| | | |
|---|---|---|
| pusch-Config | SetupRelease { PUSCH-Config } | OPTIONAL, |

-- Need M

| | |
|---|---|
| configuredGrantConfig | SetupRelease { ConfiguredGrantConfig } |

OPTIONAL, -- Need M

| | | |
|---|---|---|
| srs-Config | SetupRelease { SRS-Config } | OPTIONAL, |

-- Need M

| | |
|---|---|
| beamFailureRecoveryConfig | SetupRelease { BeamFailureRecoveryConfig } |

```
OPTIONAL, -- Cond SpCellOnly
  ...,
  [[
```

| | |
|---|---|
| sl-PUCCH-Config-r16 | SetupRelease { PUCCH-Config } |

OPTIONAL, -- Need M

| | | |
|---|---|---|
| cp-ExtensionC2-r16 | INTEGER (1..28) | OPTIONAL, |

-- Need R

| | | |
|---|---|---|
| cp-ExtensionC3-r16 | INTEGER (1..28) | OPTIONAL, |

-- Need R

| | |
|---|---|
| useInterlacePUCCH-PUSCH-r16 | ENUMERATED {enabled} |

OPTIONAL, -- Need R

| | |
|---|---|
| pucch-ConfigurationList-r16 | SetupRelease { PUCCH-ConfigurationList-r16 } |

OPTIONAL, -- Need M

| | |
|---|---|
| lbt-FailureRecoveryConfig-r16 | SetupRelease { LBT-FailureRecoveryConfig-r16 } |

OPTIONAL, -- Need M
configuredGrantConfigToAddModList-r16

| | |
|---|---|
| ConfiguredGrantConfigToAddModList-r16 | OPTIONAL, -- Need N |
| configuredGrantConfigToReleaseList-r16 | ConfiguredGrantConfigToReleaseList- |

| | |
|---|---|
| r16 | OPTIONAL, -- Need N |

configuredGrantConfigType2DeactivationStateList-r16

| | |
|---|---|
| ConfiguredGrantConfigType2DeactivationStateList-r16 | OPTIONAL -- Need R |

```
  ]],
  [[
```

| | |
|---|---|
| ul-TCI-StateList-r17 | CHOICE { |
| explicitlist | SEQUENCE { |

| | |
|---|---|
| ul-TCI-ToAddModList-r17 | SEQUENCE (Size (1..maxUL-TCI-r17)) OF TCI- |

| | |
|---|---|
| UL-State-r17 | OPTIONAL, -- Need N |

| | |
|---|---|
| ul-TCI-ToReleaseList-r17 | SEQUENCE (SIZE (1..maxUL-TCI-r17)) OF TCI- |

| | |
|---|---|
| UL-State-Id-r17 | OPTIONAL -- Need N |

},

| | |
|---|---|
| unifiedTCI-StateRef-r17 | ServingCellAndBWP-Id-r17 |

| | |
|---|---|
| } | OPTIONAL, -- Need R |

| | | |
|---|---|---|
| ul-powerControl-r17 | Uplink-powerControlId-r17 | OPTIONAL, |

-- Cond NoTCI-PC

| | |
|---|---|
| pucch-ConfigurationListMulticast1-r17 | SetupRelease { PUCCH-ConfigurationList-r16 } |

OPTIONAL, -- Need M

| | |
|---|---|
| pucch-ConfigurationListMulticast2-r17 | SetupRelease { PUCCH-ConfigurationList-r16 } |

```
OPTIONAL -- Need M
  ]],
  [[
```

| | |
|---|---|
| pucch-ConfigMulticast1-r17 | SetupRelease { PUCCH-Config } |

OPTIONAL, -- Need M

| | |
|---|---|
| pucch-ConfigMulticast2-r17 | SetupRelease { PUCCH-Config } |

```
OPTIONAL -- Need M
  ]],
  [[
```

| | | |
|---|---|---|
| pathlossReferenceRSToAddModList-r17 | SEQUENCE | (SIZE |

(1..maxNrofPathlossReferenceRSs-r17)) OF PathlossReferenceRS-r17

| | OPTIONAL, -- Need N | |
|---|---|---|
| pathlossReferenceRSToReleaseList-r17 | SEQUENCE | (SIZE |

(1..maxNrofPathlossReferenceRSs-r17)) OF PathlossReferenceRS-Id-r17
OPTIONAL -- Need N
]]
}

| | | | |
|---|---|---|---|
| ConfiguredGrantConfigToAddModList-r16 | ::= | SEQUENCE | (SIZE |

(1..maxNrofConfiguredGrantConfig-r16)) OF ConfiguredGrantConfig

| | | | |
|---|---|---|---|
| ConfiguredGrantConfigToReleaseList-r16 | ::= | SEQUENCE | (SIZE |

(1..maxNrofConfiguredGrantConfig-r16)) OF ConfiguredGrantConfigIndex-r16

| | | | |
|---|---|---|---|
| ConfiguredGrantConfigType2DeactivationState-r16 | ::= | SEQUENCE | (SIZE |

(1..maxNrofConfiguredGrantConfig-r16)) OF ConfiguredGrantConfigIndex-r16
ConfiguredGrantConfigType2DeactivationStateList-r16 ::=

SEQUENCE (SIZE (1..maxNrofCG-Type2DeactivationState)) OF

ConfiguredGrantConfigType2DeactivationState-r16
-- TAG-BWP-UPLINKDEDICATED-STOP
-- ASN1STOP

Table 1 below indicates BWP-UplinkDedicated field descriptions.

TABLE 1
BWP-UplinkDedicated field descriptions

beamFailureRecoveryConfig
Configuration of beam failure recovery. If supplementaryUplink is present, the field is
present only in one of the uplink carriers, either UL or SUL.
configuredGrantConfig
A Configured-Grant of type1 or type2. It may be configured for UL or SUL but in case of
type1 not for both at a time. Except for reconfiguration with sync, the NW does not
reconfigure configuredGrantConfig when there is an active configured uplink grant Type 2
(see TS 38.321 [3]). However, the NW may release the configuredGrantConfig at any time.
Network can only configure configured grant in one BWP using either this field or
configuredGrantConfigToAddModList.
configuredGrantConfigToAddModList
Indicates a list of one or more configured grant configurations to be added or modified for
one BWP. Except for reconfiguration with sync, the NW does not reconfigure a Type 2
configured grant configuration when it is active (see TS 38.321 [3]). The network configures
multiple CG configurations for one BWP with either all configurations or no configuration
configured with cg-RetransmissionTimer-r16.
configuredGrantConfigToReleaseList
Indicates a list of one or more UL Configured Grant configurations to be released. The NW
may release a configured grant configuration at any time.
configuredGrantConfigType2DeactivationStateList
Indicates a list of the deactivation states in which each state may be mapped to a single or
multiple Configured Grant type 2 configurations to be deactivated when the corresponding
deactivation DCI is received, see clause 7.3.1 in TS 38.212 [17] and clause 10.2 in TS
38.213 [13].
cp-ExtensionC2, cp-ExtensionC3
Configures the cyclic prefix (CP) extension (see TS 38.211 [16], clause 5.3.1). For 15 kHz
SCS, {1 . . . 28} are valid for both cp-ExtensionC2 and cp-ExtensionC3. For 30 kHz SCS,
{1 . . . 28} are valid for cp-ExtensionC2 and {2 . . . 28} are valid for cp-ExtensionC3. For 60 kHz
SCS, {2 . . . 28} are valid for cp-ExtensionC2 and {3 . . . 28} are valid for cp-ExtensionC3.
lbt-FailureRecoveryConfig
Configures parameters used for detection of consistent uplink LBT failures for operation
with shared spectrum channel access, as specified in TS 38.321 [3].
pathlossReferenceRSToAddModList
A list of reference signals (e.g., a CSI-RS config or a SS block) to be used for path loss
estimation for PUSCH, PUCCH and SRS for unified TCI state operation. If unifiedTCI-
StateType is not configured for the serving cell, no element in this list is configured.
pucch-Config
PUCCH configuration for one BWP of the normal UL or SUL of a serving cell. If the UE is
configured with SUL, the network configures PUCCH only on the BWPs of one of the
uplinks (normal UL or SUL). The network configures PUCCH-Config at least on non-initial
BWP(s) for SpCell and PUCCH SCell. If supported by the UE, the network may configure
at most one additional SCell of a cell group with PUCCH-Config (i.e. PUCCH SCell). If
PUCCH cell switching is supported by the UE, the network may configure two TDD serving
cells with PUCCH-Config within each PUCCH group. For supporting PUCCH cell
switching in the PUCCH group with the SpCell, the TDD SpCell and one TDD SCell shall
have PUCCH-Config on their normal UL. For supporting PUCCH cell switching in the
PUCCH group with only SCells, two TDD SCells shall have PUCCH-Config on their normal
UL.
In (NG)EN-DC and NE-DC, the NW configures at most one serving cell per frequency range
with PUCCH. In (NG)EN-DC and NE-DC, if two PUCCH groups are configured, the
serving cells of the NR PUCCH group in FR2 use the same numerology. For NR-DC, the
maximum number of PUCCH groups in each cell group is one, and only the same
numerology is supported for the cell group with carriers only in FR2.
The NW may configure PUCCH for a BWP when setting up the BWP. The network may
also add/remove the pucch-Config in an RRCReconfiguration with reconfigurationWithSync
or LTM candidate cell configuration or LTM reference configuration (for SpCell or PUCCH
SCell) or with SCell release and add (for PUCCH SCell) to move the PUCCH between the
configured pucch-Config are allowed.
UL and SUL carrier of one serving cell. In other cases, only modifications of a previously
If one (S)UL BWP of a serving cell is configured with PUCCH, all other (S)UL BWPs
must be configured with PUCCH, too.
pucch-ConfigurationList
PUCCH configurations for two simultaneously constructed HARQ-ACK codebooks (see
TS 38.213 [13], clause 9.1). Different PUCCH Resource IDs are configured in different
PUCCH-Config within the pucch-ConfigurationList if configured.
pucch-ConfigurationListMulticast1
PUCCH configurations for two simultaneously constructed HARQ-ACK codebooks for
MBS multicast (see TS 38.213, clause 9).
pucch-ConfigurationListMulticast2
PUCCH configurations for two simultaneously constructed NACK-only feedback for MBS
multicast (see TS 38.213, clause 9).
pusch-Config
PUSCH configuration for one BWP of the normal UL or SUL of a serving cell. If the UE is
configured with SUL and if it has a PUSCH-Config for both UL and SUL, an UL/SUL
indicator field in DCI indicates which of the two to use. See TS 38.212 [17], clause 7.3.1.
pucch-ConfigMulticast1
PUCCH configuration for the HARQ-ACK codebook for MBS multicast when multicast
feedback is not configured with a priority value (see TS 38.213 [13], clause 9). If the field
is not configured, pucch-Config applies.
pucch-ConfigMulticast2
PUCCH configuration for the NACK-only feedback for MBS multicast when multicast
feedback is not configured with a priority value (see TS 38.213 [13], clause 9). If the field
is not configured, pucch-Config applies.
sl-PUCCH-Config
Indicates the UE specific PUCCH configurations used for the HARQ-ACK feedback
reporting for NR sidelink communication.
srs-Config
Uplink sounding reference signal configuration.
ul-powerControl
Configures power control parameters for PUCCH, PUSCH and SRS when UE is
configured with unifiedTCI-StateType for this serving cell. For each serving cell, ul-
powerControl is either configured in all BWP-UplinkDedicated or it is not configured in
any BWP-UplinkDedicated. When unifiedTCI-StateRef in the BWP-UplinkDedicated of a
serving cell refers to another serving cell, ul-powerControl is either configured in all BWP-
UplinkDedicated of these two serving cells or it is not configured in any BWP-
UplinkDedicated of these two serving cells.
ul-TCI-StateList
Indicates the applicable UL TCI states for PUCCH, PUSCH and SRS.
ul-TCI-ToAddModList
Indicates a list of UL TCI states.
unifiedTCI-StateRef
Provides the serving cell and UL BWP where UL TCI states applicable to this UL BWP
are defined.
useInterlacePUCCH-PUSCH
If the field is present, the UE uses uplink frequency domain resource allocation Type 2 for
PUSCH (see TS 38.213 [13], clause 8.3 and TS 38.214 [19], clause 6.1.2.2) and uses
interlaced PUCCH Format 0, 1, 2, and 3 for PUCCH (see TS 38.213 [13], clause 9.2.1).

Table 2 below indicates optional field descriptions of BWP-UplinkDedicated field.

TABLE 2

| Conditional Presence | Explanation |
|---|---|
| NoTCI-PC | The field is optionally present, Need R, if unifiedTCI-StateType |
| | is configured for this serving cell and ul-powerControl is not |
| | configured for any UL TCI state or joint TCI state of this serving |
| | cell. Otherwise, it is absent, Need R |
| SpCellOnly | The field is optionally present, Need M, in the BWP- |
| | UplinkDedicated of an SpCell. It is absent otherwise. |

In an embodiment herein, the gNB 102 includes configurations of TCI states for the candidate cells in the LTM reference configuration. In an embodiment herein, the gNB 102 includes configurations of TCI states for the candidate cells in the LTM candidate cell configurations, if the LTM candidate cell configurations are complete configurations. In an embodiment herein, the gNB 102 excludes configurations of TCI states for the candidate cells in the LTM candidate cell configurations if the LTM candidate cell configurations are delta configurations. UE applies (uses) the TCI states for the candidate cells in the LTM reference configuration after the LTM cell switch.

In an embodiment herein, the gNB 102 includes RACH configuration for early Timing Advance acquisition in the LTM reference configuration. In an embodiment herein, the gNB 102 includes RACH configuration for early Timing Advance acquisition for the candidate cells in the LTM candidate cell configurations, if (and only if) the LTM candidate cell configurations are complete configurations. In an embodiment herein, the gNB 102 excludes RACH configuration for early Timing Advance acquisition in the LTM candidate cell configurations, if the LTM candidate cell configurations are delta configurations.

In an embodiment herein, the gNB 102 includes a reference signal configuration for the candidate cells in the LTM candidate cell configurations if (and only if) the LTM candidate cell configurations are complete configurations.

In an embodiment herein, MN-SN interaction for LTM is disclosed. The SN 130 informs MN 128, the RACH configuration for early TA acquisition (such as the timing for the RACH), it has configured for its candidate cells. In an embodiment herein, the SN 130 may communicate the RACH configuration information to MN 128 through Inter-Node RRC messages such as CG-Config. In an embodiment herein, the SN 130 informs MN 128, the RACH configuration for early TA acquisition (such as the timing for the RACH) that the SN 130 has configured for its candidate cells, for inter-frequency cells. In an embodiment herein, the SN 130 does not provide the detailed information for the RACH configuration for early TA acquisition to MN 128, but the SN 130 provides the timing of the random access to the MN 128. In an embodiment herein, the SN 130 provides information about the occurrence of RACH occasion and the RA response window where the UE 104 may listen for early TA acquisition to MN 128. In an embodiment herein, the MN 128 may not schedule the UE 104 (or send any DL data or control message) during the time when the UE 104 is sending RACH preambles in another frequency for early TA acquisition in the SN 130. In an embodiment herein, the SN 130 also may not schedule the UE 104 (or send any DL data or control message) during the time when the UE 104 is sending RACH preambles in another frequency for early TA acquisition in the SN 130.

In an embodiment herein, the MN 128 informs the SN 130, the RACH configuration for early TA acquisition (such as the timing for the RACH), MN 128 has configured for the candidate cells. In an embodiment herein, the MN 128 communicates the RACH configuration information to the SN 130 through Inter-Node RRC messages such as CG-ConfigInfo. In an embodiment herein, the MN 128 informs the SN 130, the RACH configuration for early TA acquisition (such as the timing for the RACH), the MN 128 has configured for the candidate cells, for inter-frequency cells. In another embodiment herein, the MN 128 does not provide the detailed information for the RACH configuration for early TA acquisition to the SN 130, but the MN 128 provides the timing of the random access to the SN 130. In an embodiment herein, the MN 128 provides information about the occurrence of RACH occasion and the RA response window where the UE 104 may be listening for early TA acquisition to the SN 130. In an embodiment herein, the SN 130 may not schedule (or send any DL data or control message) the UE 104 during the time when the UE 104 is sending RACH preambles in another frequency for early TA acquisition in the MN 128. In an embodiment herein, the MN 128 may not schedule (or send any DL data or control message) the UE 104 during the time when the UE 104 is sending RACH preambles in another frequency for early TA acquisition in the MN 128.

In an embodiment herein, the MN 128 sends a PDCCH order (as defined in 3gpp specifications) to deactivated SCells. In an embodiment herein, the SN 130 sends the PDCCH order (as defined in 3gpp specifications) to the deactivated SCells.

In an embodiment herein, the UE 104 performs a random access for Early TA acquisition on SCells if they are candidate cells. In an embodiment herein, the UE 104 performs a random access for early TA acquisition on SCells if they are candidate cells irrespective of the activation status of the SCell. If LTM is configured, then the network (MN or SN) indicates to the UE 104 that the UE 104 is not allowed to indicate a preference for SCG deactivation to the MN 128 (or doesn't configure the UE 104 to indicate the preference for SCG deactivation).

In an embodiment herein, if the MN 128 requests the SCG to be deactivated while LTM is configured, then the SN 130 keeps the SCG activated. In an embodiment herein, if the MN 128 requests the SCG to be deactivated while LTM is configured, then the SN 130 releases LTM configuration. In an embodiment herein, if the MN 128 requests the SCG to be deactivated while LTM is configured, then the SN 130 rejects the request and sends SCG activation deactivation failure to the MN 128. In an embodiment herein, if the MN 128 requests the SCG to be deactivated while LTM is configured, then the SN 130 rejects the request and sends SCG activation deactivation failure to the MN 128 and also informs the MN 128 that SCG deactivation is failed due to LTM candidate cell is configured.

Therefore, the proposed methods provide LTM configuration and L3 handover in equivalent SNPN. The methods provide CU-DU interaction for handling the reference signal configuration in LTM. The methods provide handling of various LTM configurations during a RRC reestablishment procedure.

FIG. 10 illustrates a structure of a base station according to an embodiment of the disclosure.

As shown in FIG. 10, the base station according to an embodiment may include a transceiver 1010, a memory 1120, and a processor 1130. The transceiver 1010, the memory 1120, and the processor 1130 of the base station may operate according to a communication method of the base station described above. However, the components of the base station are not limited thereto. For example, the base station may include more or fewer components than those described above. In addition, the processor 1130, the transceiver 1010, and the memory 1120 may be implemented as a single chip. Furthermore, the base station of FIG. 10 may correspond to the base station (102) of the FIG. 1.

The transceiver 1010 collectively refers to a base station receiver and a base station transmitter, and may transmit/receive a signal to/from a terminal (UE) or a network entity. The signal transmitted or received to or from the terminal or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1130, a signal through a wireless channel, and transmit a signal output from the processor 1130 through the wireless channel.

The memory 1120 may store a program and data required for operations of the base station. Also, the memory 1120 may store control information or data included in a signal obtained by the base station. The memory 1120 may be a storage medium, such as read-only memory (ROM), random access memory (RAM), a hard disk, a CD-ROM, and a DVD, or a combination of storage media.

The processor 1130 may control a series of processes such that the base station operates as described above. For example, the transceiver 1010 may receive a data signal including a control signal transmitted by the terminal, and the processor 1130 may determine a result of receiving the control signal and the data signal transmitted by the terminal.

FIG. 11 illustrates a structure of a UE according to an embodiment of the disclosure.

As shown in FIG. 11, the UE according to an embodiment may include a transceiver 1110, a memory 1120, and a processor 1130. The transceiver 1110, the memory 1120, and the processor 1130 of the UE may operate according to a communication method of the UE described above. However, the components of the UE are not limited thereto. For example, the UE may include more or fewer components than those described above. In addition, the processor 1130, the transceiver 1110, and the memory 1120 may be implemented as a single chip. Also, the processor 1130 may include at least one processor. Furthermore, the UE of FIG. 11 may correspond to the UE (104) of the FIG. 1.

The transceiver 1110 collectively refers to a UE receiver and a UE transmitter, and may transmit/receive a signal to/from a base station or a network entity. The signal transmitted or received to or from the base station or a network entity may include control information and data. The transceiver 1110 may include a RF transmitter for up-converting and amplifying a frequency of a transmitted signal, and a RF receiver for amplifying low-noise and down-converting a frequency of a received signal.

However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the UE. Also, the memory 1120 may store control information or data included in a signal obtained by the UE. The memory 1120 may be a storage medium, such as read-only memory (ROM), random access memory (RAM), a hard disk, a CD-ROM, and a DVD, or a combination of storage media.

The processor 1130 may control a series of processes such that the UE operates as described above. For example, the transceiver 1110 may receive a data signal including a control signal transmitted by the base station or the network entity, and the processor 1130 may determine a result of receiving the control signal and the data signal transmitted by the base station or the network entity.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

1. A method performed by a base station (BS) in a wireless communication system, the method comprising:
receiving, from a user equipment (UE), a measurement report;
identifying at least one candidate target cell for a lower layer triggered mobility (LTM) based on whether a cell supports a stand alone non public network (SNPN) identifier (ID) or an equivalent SNPN ID; and
transmitting, to the UE, configuration information on the at least one candidate target cell.

2. The method of claim 1,
wherein, in case that the cell supports the SNPN ID or the equivalent SNPN ID, the cell is configured as the at least one candidate target cell.

3. The method of claim 1,
wherein, in case that the cell does not support the SNPN ID or the equivalent SNPN ID, the cell is not configured as the at least one candidate target cell.

4. The method of claim 1,
wherein a centralized unit (CU) of the BS transmits a UE context setup request message including a reference configuration for an LTM to a distributed unit (DU), and
wherein the UE context setup request message is F1 application protocol (F1AP) message.

5. The method of claim 1,
wherein a centralized unit (CU) of the BS transmits a UE context modification request message including a reference configuration of an LTM to a distributed unit (DU), and
wherein the UE context modification request message is F1 application protocol (F1AP) message.

6. A method performed by a user equipment (UE) in a wireless communication system, the method comprising:
transmitting, to a base station (BS), a measurement report; and
receiving, from the BS, configuration information on at least one candidate target cell,
wherein the at least one candidate target cell is configured for a lower layer triggered mobility (LTM) based on whether a cell supports a stand alone non public network (SNPN) identifier (ID) or an equivalent SNPN ID.

7. The method of claim 6,
wherein, in case that the cell supports the SNPN ID or the equivalent SNPN ID, the cell is configured as the at least one candidate target cell.

8. The method of claim 6,
wherein, in case that the cell does not support the SNPN ID or the equivalent SNPN ID, the cell is not configured as the at least one candidate target cell.

9. A base station (BS) in a wireless communication system, the BS comprising:
a transceiver; and
a controller coupled with the transceiver and configured to:
receive, from a user equipment (UE), a measurement report;
identify at least one candidate target cell for a lower layer triggered mobility (LTM) based on whether a cell supports a stand alone non public network (SNPN) identifier (ID) or an equivalent SNPN ID; and
transmit, to the UE, configuration information on the at least one candidate target cell.

10. The BS of claim 9,
wherein, in case that the cell supports the SNPN ID or the equivalent SNPN ID, the cell is configured as the at least one candidate target cell.

11. The BS of claim 9,
wherein, in case that the cell does not support the SNPN ID or the equivalent SNPN ID, the cell is not configured as the at least one candidate target cell.

12. The BS of claim 9,
wherein a centralized unit (CU) of the BS transmits a UE context setup request message including a reference configuration of an LTM to a distributed unit (DU), and
wherein the UE context setup request message is F1 application protocol (F1AP) message.

13. The BS of claim 9,
wherein a centralized unit (CU) of the BS transmits a UE context modification request message including a reference configuration of an LTM to a distributed unit (DU), and
wherein the UE context modification request message is F1 application protocol (F1AP) message.

14. A user equipment (UE) in a wireless communication system, the UE comprising:
a transceiver; and
a controller coupled with the transceiver and configured to:
transmit, to a base station (BS), a measurement report; and
receive, from the BS, configuration information on at least one candidate target cell,
wherein the at least one candidate target cell is configured for a lower layer triggered mobility (LTM) based on whether a cell supports a stand alone non public network (SNPN) identifier (ID) or an equivalent SNPN ID.

15. The UE of claim 14,
wherein, in case that the cell supports the SNPN ID or the equivalent SNPN ID, the cell is configured as the at least one candidate target cell, and
wherein, in case that the cell does not support the SNPN ID or the equivalent SNPN ID, the cell is not configured as the at least one candidate target cell.
